(19) United States
(12) Patent Application Publication
(10) Pub. No.: US 2026/0080410 A1
(43) Pub. Date: Mar. 19, 2026

(54) PASSKEY-BASED AUTHENTICATION FOR THE 3-D SECURE PROTOCOL

(71) Applicant: American Express Travel Related Services Company, Inc., New York, NY (US)

(72) Inventors: Brandon M. Iannelli, Gilbert, AZ (US); Ajay Babu Maddukuri, Phoenix, AZ (US); Sundeep Kumar Alampally, Scottsdale, AZ (US); Mukund Shankar SimhaRaghu, Glendale, AZ (US); John J. Kieley, Scottsdale, AZ (US)

(21) Appl. No.: 18/886,958

(22) Filed: Sep. 16, 2024

(51) Int. Cl. G06Q 20/40; G06Q 20/38

(52) U.S. Cl. CPC G06Q 20/40145; G06Q 20/3825

(57) ABSTRACT

Disclosed are various embodiments for integrating the use of passkeys in the 3-D SECURE authentication protocol for transactions. A user of a client device can be prompted to enter a secondary factor of authentication for a second transaction, wherein the prompt includes transaction information and merchant information. In response to a selection to enter the secondary factor of authentication, biometric authentication of the user of the client device can be performed. In response to successful biometric authentication of the second transaction, a challenge comprising the transaction information and the merchant information can be cryptographically signed with a private passkey. The cryptographic signature of the challenge can then be sent to the transaction authorization service.

### BACKGROUND

Various security mechanisms are used to secure transactions made using payment instruments. For example, when using a payment card to make an in-person purchase with a merchant, multiple factors of authentication can be used to verify the transaction. Government issued photographic identification (e.g., a driver's license, passport, etc.) can be used to verify the identity of the purchaser. Features on the physical card, such as the imprint of the name of the account holder, can show that the purchaser is the account holder or an authorized user. Moreover, other security features built into the card, such as the Europay-Mastercard-VISA (EMV) chip, can be used to verify that the card is not fake or a counterfeit. Collectively, these datapoints can be used to determine the identity of the purchaser, the authenticity of the payment instrument, and authority of the purchaser to use the payment instrument. Additional security features can improve the confidence of these determinations.

However, electronic purchases (e.g., over the Internet) lack these security features that can be used to prevent fraudulent purchases. For example, payment instrument information (e.g., a credit, debit, or charge card number; expiration date; security code; billing address; etc.) could have been stolen. The identify of the purchaser is supplied by the purchaser (e.g., a purchaser's legal name is entered by the purchaser during a user account creation process), which requires the merchant to rely on the purchaser to honestly identify himself or herself rather than a fraudster impersonating another individual.

Various solutions have been created in order to attempt to remedy the security and fraud risks associated with internet commerce. For example, the 3-D SECURE® protocol (offered to customers under brands such as VISA SECURE®, MASTERCARD IDENTITY CHECK®, DISCOVER PROTECTBUY®, and AMERICAN EXPRESS SAFEKEY®) allows for payment processing networks (e.g., VISA®, MASTERCARD®, DISCOVER®, and AMERICAN EXPRESS®) to provide additional layers of security for debit, credit, or charge card transactions online. In most current implementations of the 3-D SECURE protocol, the card issuer can prompt the purchaser for a password that is only know to the card issuer and the purchaser. In some implementations, this could involve the static, pre-existing, previously shared password. In other implementations, this could involve sending a one-time password (OTP) to an email address or phone number previously registered with the card issuer, which the purchaser could then submit using the 3-D SECURE prompt.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-9 are pictorial diagrams depicting an example user journey for enrolling a client device for subsequent 3-D SECURE authentications using passkeys.

FIGS. 10-17 are pictorial diagrams depicting an example user journey for authenticating a client device using 3-D SECURE authentication with passkeys.

FIG. 18 is a drawing of a network environment according to various embodiments of the present disclosure.

FIGS. 19A and 19B are sequence diagrams depicting example processes within the network environment of FIG. 18 for enrolling a client device for subsequent 3-D SECURE authentications using passkeys.

FIGS. 20A and 20B are sequence diagrams depicting example processes within the network environment of FIG. 18 for authenticating a client device using 3-D SECURE authentication with passkeys.

### DETAILED DESCRIPTION

Disclosed are various approaches for integrating more secure and user-friendly authentication mechanisms into the 3-D SECURE protocol. For example, the 3-D SECURE protocol does not support or provide for integration with authentication protocols such as WebAuthN, a web standard published by the World Wide Web Consortium (W3C). The WebAuthN standard allows for authentication with applications and services using cryptographic keys referred to as passkeys.

The WebAuthN standard provides a number of advantages over password-based authentication, such as the password-based authentication mechanisms used by the 3-D SECURE protocol. For example, WebAuthN provides for more secure generation and storage of authentication credentials by generating unique cryptographic keypairs for each website. This eliminates common vulnerabilities such as weak passwords, predictable passwords, guessable passwords, poor client-side password storage, password reuse across multiple websites, inadequate password requirements, etc. As another example, WebAuthN never stores the private encryption key on a server, eliminating risks related to insecure password storage or database leaks exposing passwords. For one-time password systems, such as systems implementing the 3-D SECURE protocol, this also eliminates the risk associated with the seed value for a one-time password algorithm being insecurely stored and/or leaked, thereby allowing malicious parties to generate valid one-time passwords while the seed value remains valid.

However, WebAuthN does not always support third-party contexts. In some versions of the WebAuthN protocol, as well as some browser implementations of the WebAuthN, protocol, the use of passkeys is restricted to the first-party context only. For example, when an issuer determines that the 3-D SECURE protocol is to be used to authenticate a transaction, the merchant's website can open an iFrame to allow the issuer to collect a password (e.g., a one-time password) from the user or otherwise authenticate the user. Because the iFrame contains content originating from the issuer, while the parent node in the document object model (DOM) of the merchant website contains content originating from the merchant, the iFrame is operating as a cross-origin iFrame (also referred to as the third-party context). In these versions and implementations, the iFrame is prohibited from accessing content associated with the originating domain of the iFrame, and therefore the domain of the issuer, as a security measure. However, more recent versions of the WebAuthN protocol and more recent browser implementations of the WebAuthN support third-party contexts. In these versions and implementations, when the merchant's website opens an iFrame to allow the issuer to collect a password (e.g., a one-time password) from the user or otherwise authenticate the user, the iFrame can rely upon passkeys associated with the originating domain of the issuer, and therefore the originating domain of the iFrame, for authentication. Therefore, the various embodiments of the present disclosure take into account the different versions of the WebAuthN protocol supported by a client device in order to integrate WebAuthN into the 3-D SECURE protocol for authentication purposes.

Accordingly, the various embodiments of the present disclosure provide for an improvement to authentication systems that implement or rely upon the 3-D SECURE protocol. The various embodiments of the present disclosure allow for existing implementations of the 3-D SECURE protocol to implement the WebAuthN protocol to allow for the use of biometrics and passkeys for authentication of the purchaser in an online electronic commerce application.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

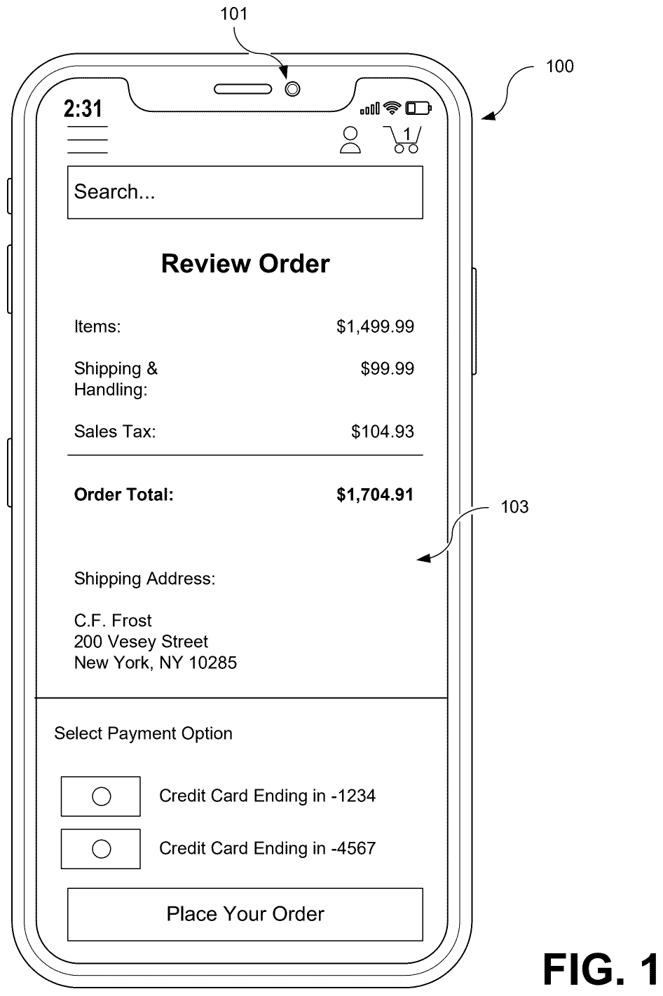

FIG. 1 depicts an example of a user experience according to various embodiments of the present disclosure. In particular, FIG. 1 depicts the beginning of a user journey whereby a purchaser registers with or enrolls with a 3-D SECURE system provided by an issuer in order to use WebAuthN for future authentications of transactions.

Here, the purchaser could be completing the checkout process on his or her client device 100. The client device 100 could include a number of components, such as a display screen, microphone, front-facing camera 101 (e.g., for use with facial recognition), fingerprint reader, or other components. The client device could display a first user interface 103 generated by a merchant website or other electronic commerce application or system. The first user interface 103 could be in the form of a webpage rendered within browser or a user interface for a dedicated application. User interfaces for a dedicated application could be hard coded or could be implemented with a WebView, which is a web browser embedded within an application to allow the use of web content within the application. A WebView is often used for standalone mobile applications developed for and executed on mobile devices (e.g., smart phones, tablets, etc.). In some instances, the entire functionality of an application, such as a mobile application, could be implemented using a WebView.

The user interface 103 could display various information to the purchaser as part of the checkout process. This could include information such as the purchase price for any items or services to be purchased, shipping costs, sales tax, and/or other costs. This information could also include the name and address of the recipient of the goods or services (e.g., for shipping or delivery purposes), the name and billing address of the purchaser, and one or more payment options (e.g., previously stored or saved payment instruments). The purchaser could, therefore, visually confirm that his or her purchase is correct, select a payment option (e.g., a previously stored credit, debit, or charge card; enter information for a new payment instrument; etc.), and the press, click, or otherwise interact with the user interface 103 to continue (e.g., by pressing the “Place Your Order” button).

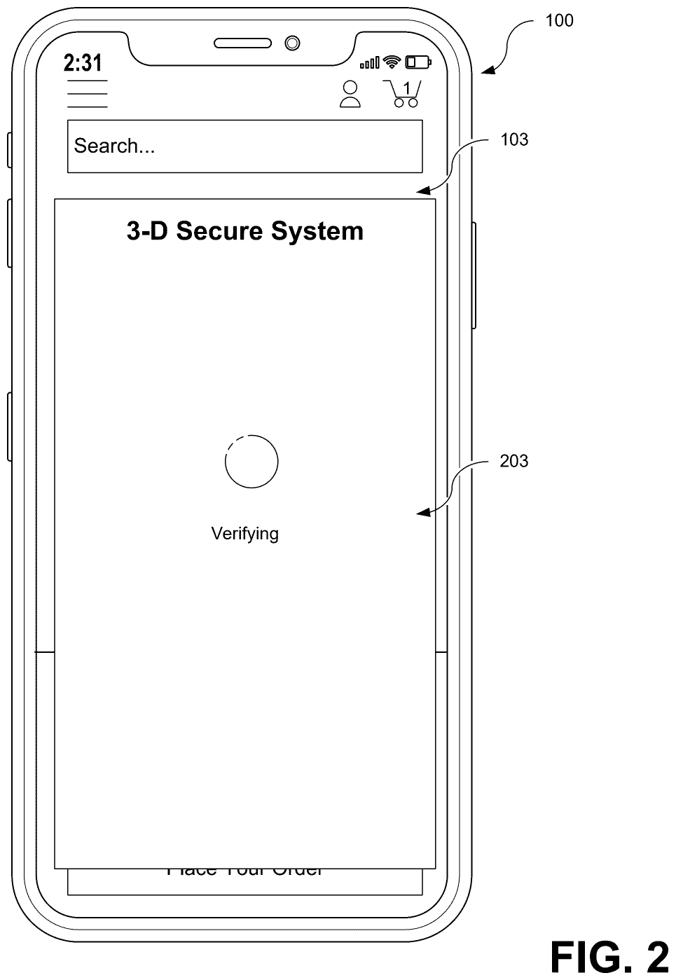

In response to placing an order with the user interface 103 of FIG. 1, the purchaser could be presented with a message indicating that the transaction is being verified, as depicted in FIG. 2, using the 3-D SECURE protocol. In many implementations, the message could be presented within an HTML inline frame (iFrame) originating from a domain associated with, owned by, or otherwise controlled by the issuer, such as iFrame 203. The use of the iFrame 203 allows for the issuer to walk the purchaser through the 3-D SECURE verification process without requiring the purchaser to leave the user interface 103 (e.g., website or application) through which the purchase was made.

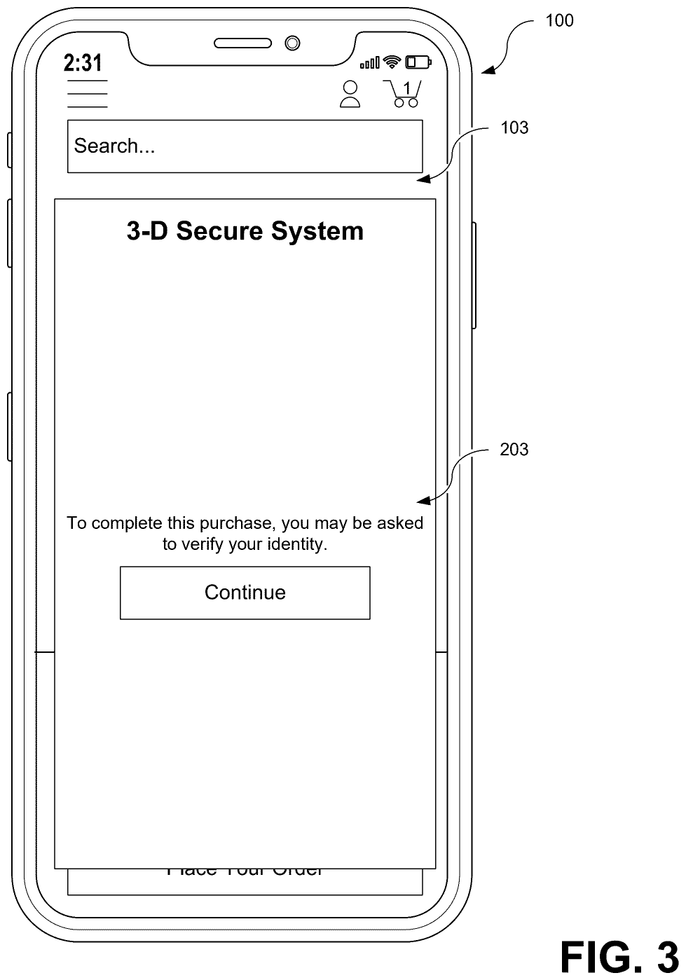

Subsequently, as illustrated in FIG. 3, the purchaser could be presented with a message within the iFrame 203 that the purchaser will need to verify his or her identity to complete the purchase. The purchaser can then be given the option to continue with the verification process. If the purchaser chooses not to complete or proceed with the verification process, then the purchase can be deemed to be abandoned and cancelled by either the merchant or the issuer.

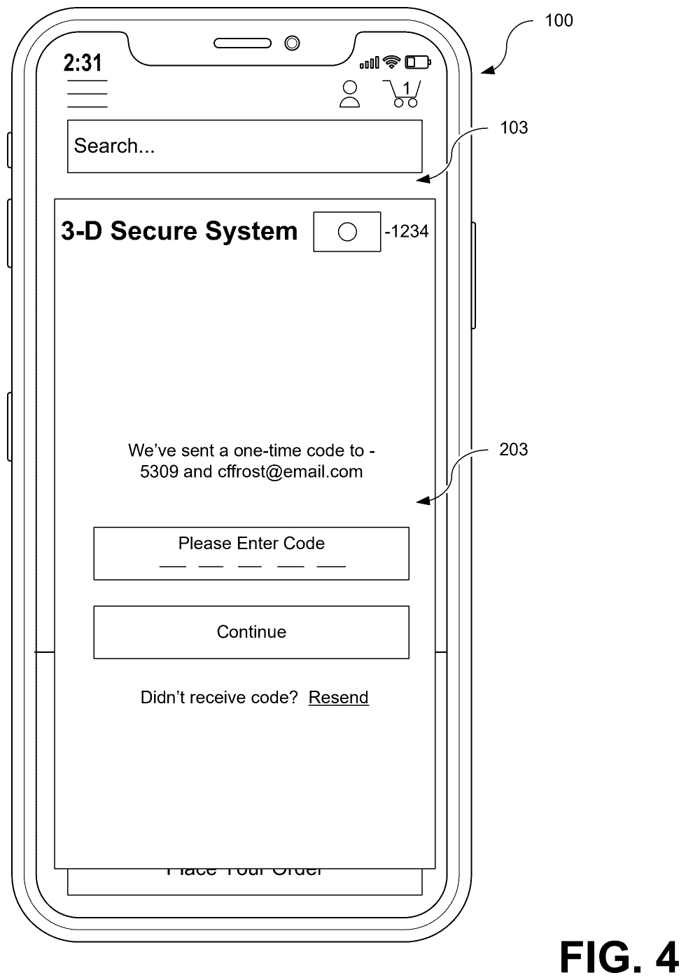

Accordingly, if the purchaser proceeds to FIG. 4, then the purchaser could be prompted to enter within the iFrame 203 a password, passcode, personal identification number, or some other secret known only to the purchaser and the issuer. For example, the purchaser could be notified that a one-time password (OTP) or passcode has been sent to an email address or phone number associated with the owner of the payment option selected in FIG. 1. Entry of the password, passcode, personal identification number, or other secret (e.g., one-time password) would therefore verify that the purchaser is the owner or authorized user of the selected payment option.

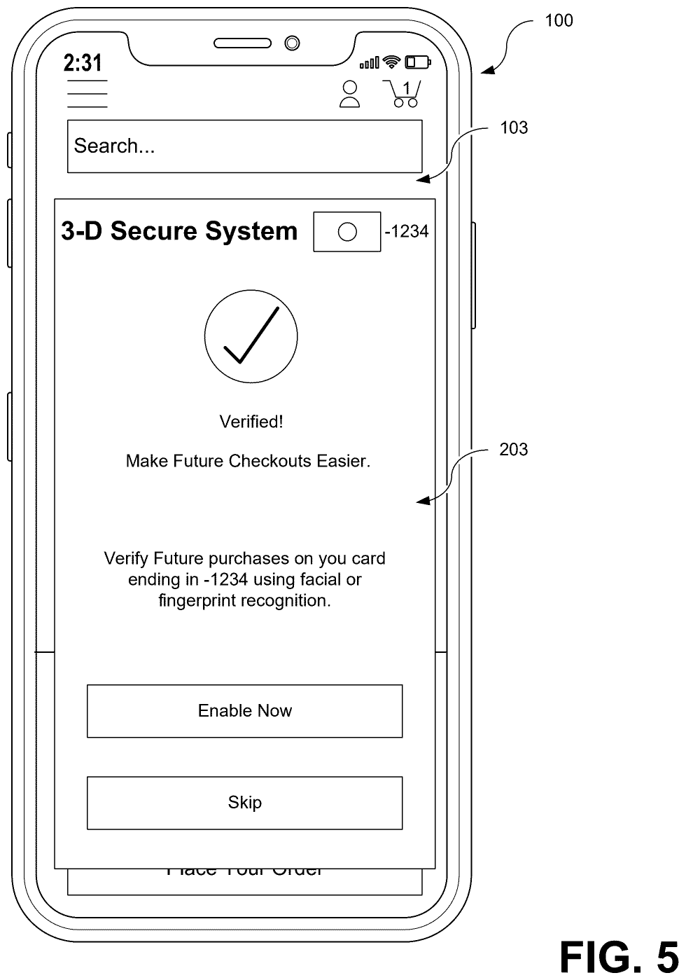

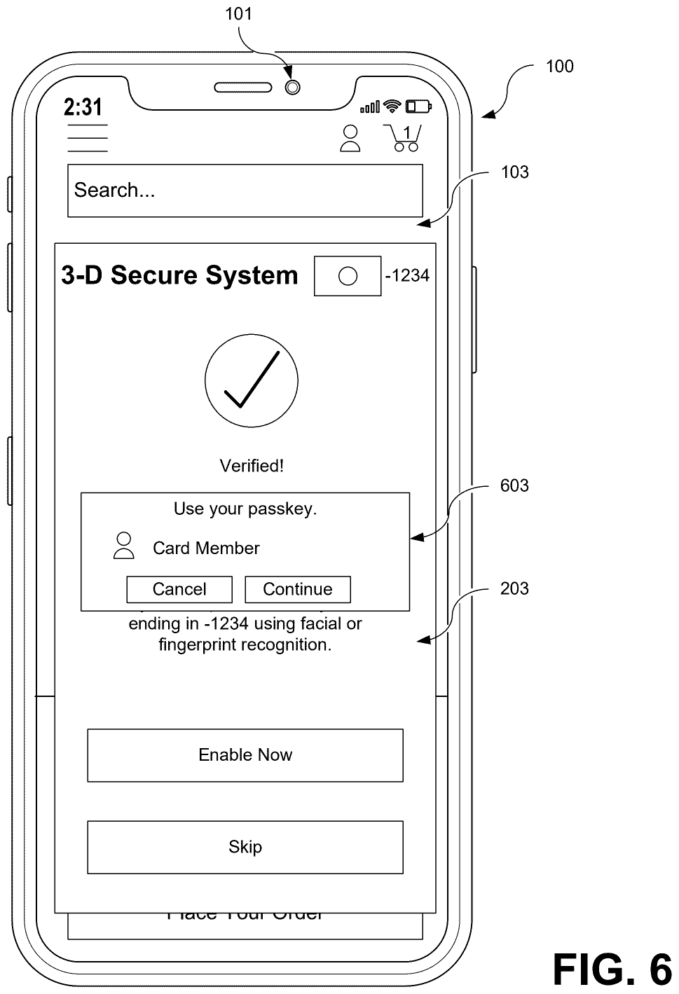

After the purchaser has verified his or her identity to the issuer, the issuer could prompt the purchaser to enroll for with the issuer's implementation of the various embodiments of the present disclosure, as depicted in FIG. 5. If the purchaser selects to enroll, then the purchaser could be presented with the user interface as depicted in FIG. 6.

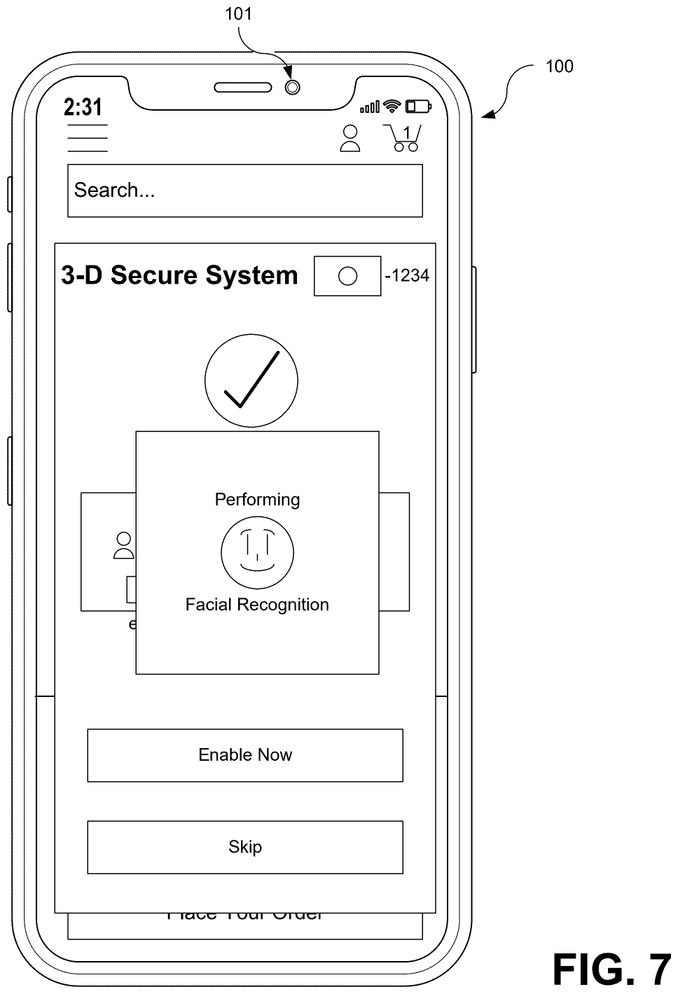

As depicted in FIG. 6, the purchaser could be presented with a user interface element 603 (e.g., a dialog box or other prompt or input mechanism) asking the purchaser to use his or her passkeys already associated with the issuer. The purchaser could then authorize the use of his or her passkeys though various authentication mechanisms offered by the client device 100. For example, the purchaser could use the front-facing camera 101 to perform facial recognition to verify his or her identity in order to authorize the use of his or passkeys, as illustrated in FIG. 7. As another example, the purchaser could use a fingerprint reader installed on the client device 100 to authenticate his or her identity using his or her fingerprint. Other mechanisms (e.g., entering a personal identification number (PIN) or passcode to authorize access to the passkeys) could also be used.

Although the user interface depicted in FIG. 6 illustrates the use of passkeys within the iFrame 203 to authenticate himself or her, this depiction would only work for embodiments where the version of the WebAuthN protocol being used and the version of a client application or browser on the client device 100 support the use of passkeys in a cross-origin iFrame or third-party context. In those implementations where the version of the WebAuthN protocol or client application or browser do not support the use of passkeys in a cross-origin iFrame or third-party context, the client device 100 could open a tab in a browser, which could be depicted as a separate screen of the client application containing a separate WebView. The new tab or WebView could be opened to point to the domain associated with the iFrame 203, thereby placing the new tab or WebView in the first-party context. Authentication with the passkeys of the user would then be permitted.

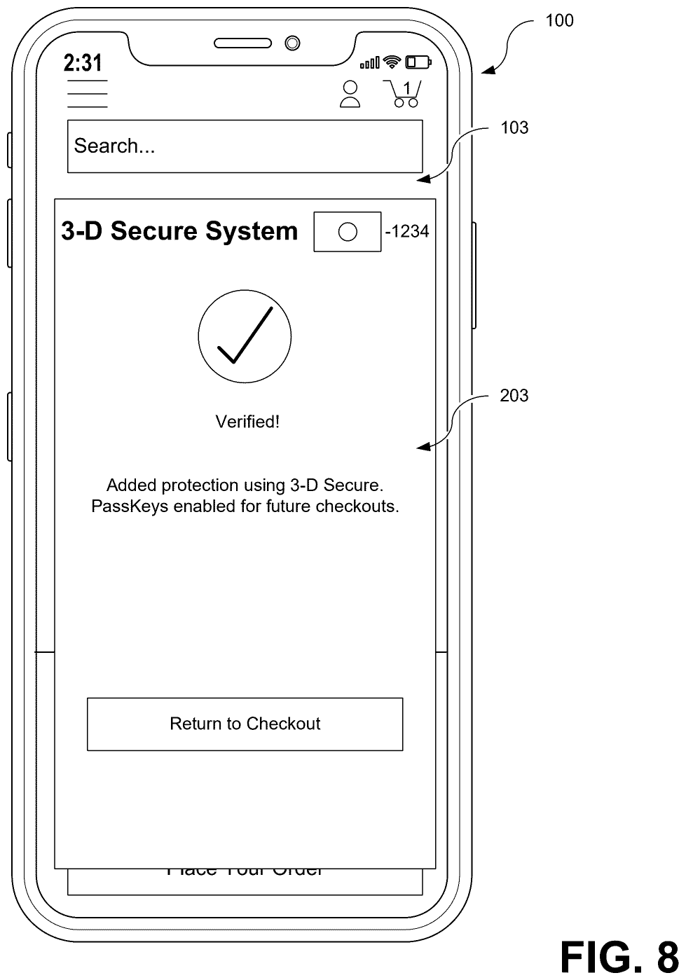

After authorizing the use of his or her passkeys, as depicted in FIG. 7, the registration process could proceed to FIG. 8. Here, a message could be presented to the purchaser within the iFrame 203 to indicate that the purchaser has not only been verified, but that passkeys have been enabled to facilitate future authentication using the 3-D SECURE® protocol. The purchaser could also be prompted to leave the iFrame 203 and return to the checkout process.

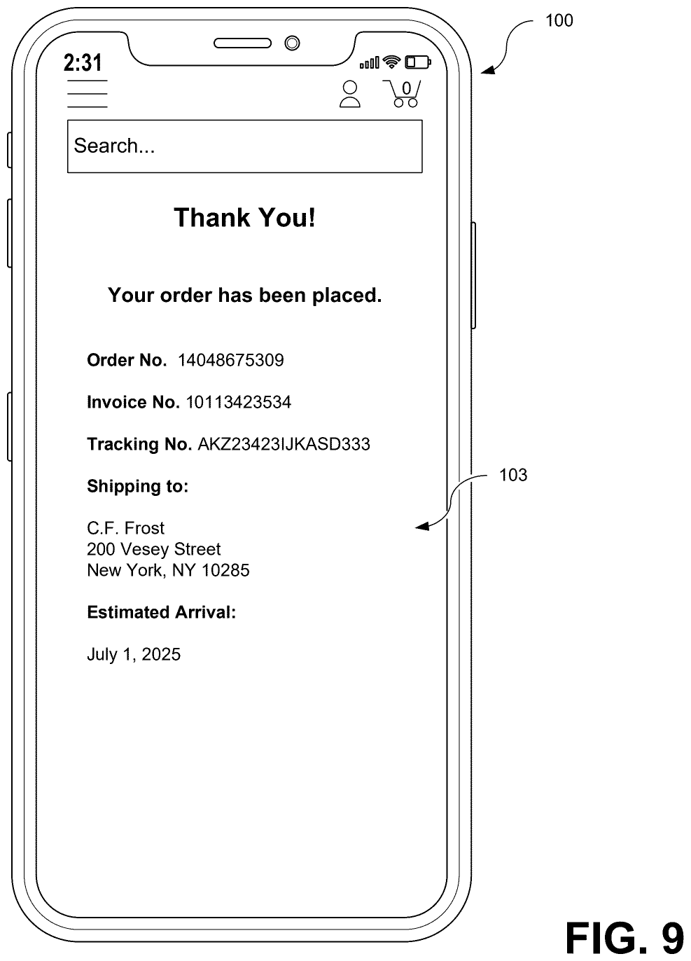

As illustrated in FIG. 9, the iFrame 203 could be closed and the purchaser could be presented within the user interface 103 with updated information related to his or her purchase. This could include a confirmation that the order is complete, estimated arrival, an order number, invoice number, etc.

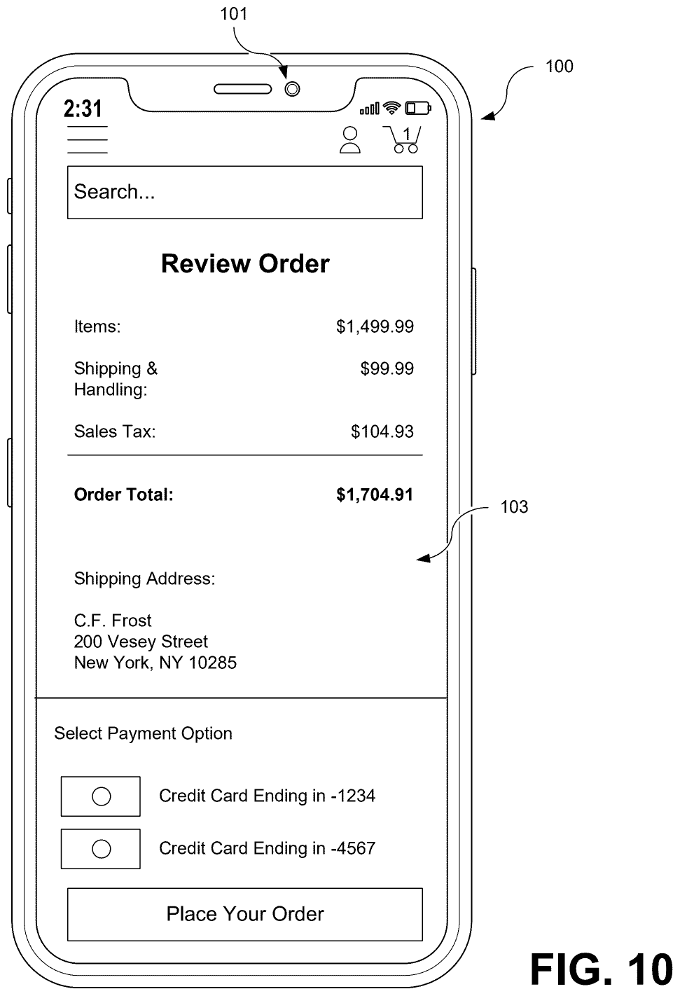

FIG. 10 depicts an example of a user experience according to various embodiments of the present disclosure. In particular, FIG. 10 depicts the beginning of a user journey whereby a purchaser who has previously registered his or her passkeys for use in a 3-D SECURE authentication system places a purchase that will be authenticated using the various embodiments of the present disclosure. Here, the purchaser could be completing the checkout process on his or her client device 100. The client device 100 could include a number of components, such as a display screen, microphone, front-facing camera 101 (e.g., for use with facial recognition), fingerprint reader, or other components. The client device could display a first user interface 103 generated by a merchant website or other electronic commerce application or system. The first user interface 103 could be in the form of a webpage rendered within browser or a user interface for a dedicated application. User interfaces for a dedicated application could be hard coded or could be implemented with a WebView, which is a web browser embedded within an application to allow the use of web content within the application. WebViews are often used for standalone mobile applications developed for and executed on mobile devices (e.g., smart phones, tablets, etc.). In some instances, the entire functionality of an application, such as a mobile application, could be implemented using a WebView.

The user interface 103 could display various information to the purchaser as part of the checkout process. This could include information such as the purchase price for any items or services to be purchased, shipping costs, sales tax, and/or other costs. This information could also include the name and address of the recipient of the goods or services (e.g., for shipping or delivery purposes), the name and billing address of the purchaser, and one or more payment options (e.g., previously stored or saved payment instruments). The purchaser could, therefore, visually confirm that his or her purchase is correct, select a payment option (e.g., a previously stored credit, debit, or charge card; enter information for a new payment instrument; etc.), and the press, click, or otherwise interact with the user interface 103 to continue (e.g., by pressing the “Place Your Order” button).

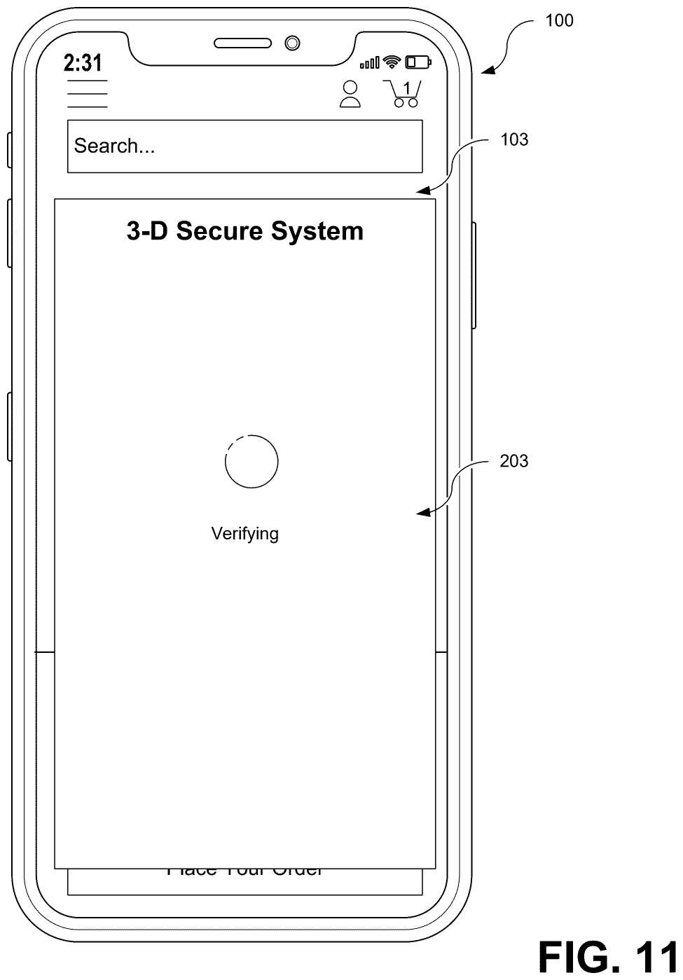

In response to placing an order with the user interface 103 of FIG. 10, the purchaser could be presented with a message indicating that the transaction is being verified, as depicted in FIG. 11, using the 3-D SECURE protocol. In many implementations, the message could be presented within an HTML inline frame (iFrame) originating from a domain associated with, owned by, or otherwise controlled by the issuer, such as iFrame 203. The use of the iFrame 203 allows for the issuer to walk the purchaser through the 3-D SECURE verification process without requiring the purchaser to leave the user interface 103 (e.g., website or application) through which the purchase was made.

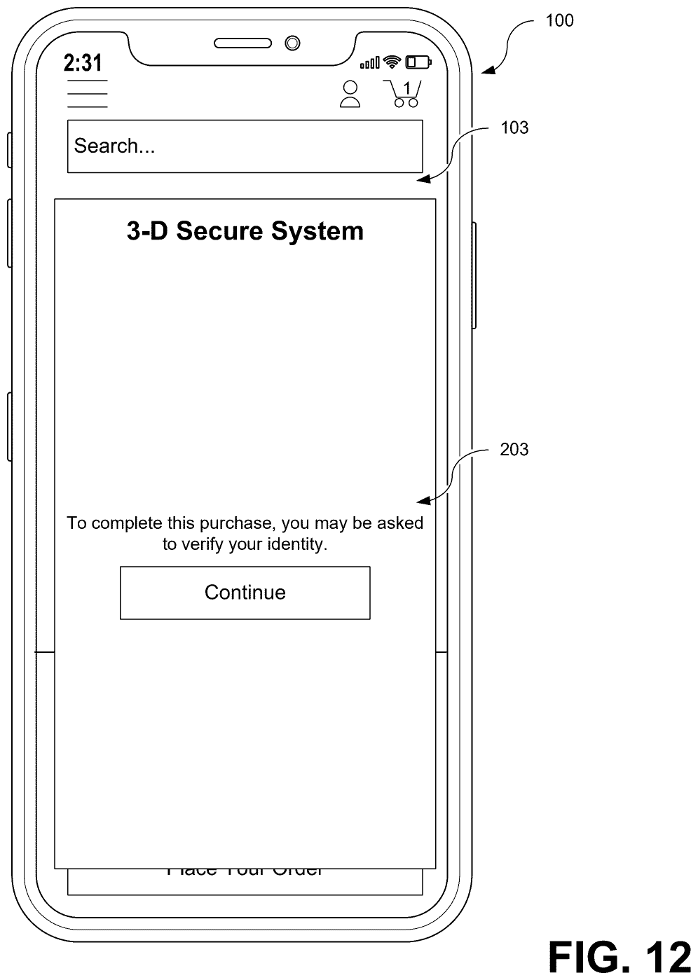

Subsequently, as illustrated in FIG. 12, the purchaser could be presented with a message within the iFrame 203 that the purchaser will need to verify his or her identity to complete the purchase. The purchaser can then be given the option to continue with the verification process. If the purchaser chooses not to complete or proceed with the verification process, then the purchase can be deemed to be abandoned and cancelled by either the merchant or the issuer.

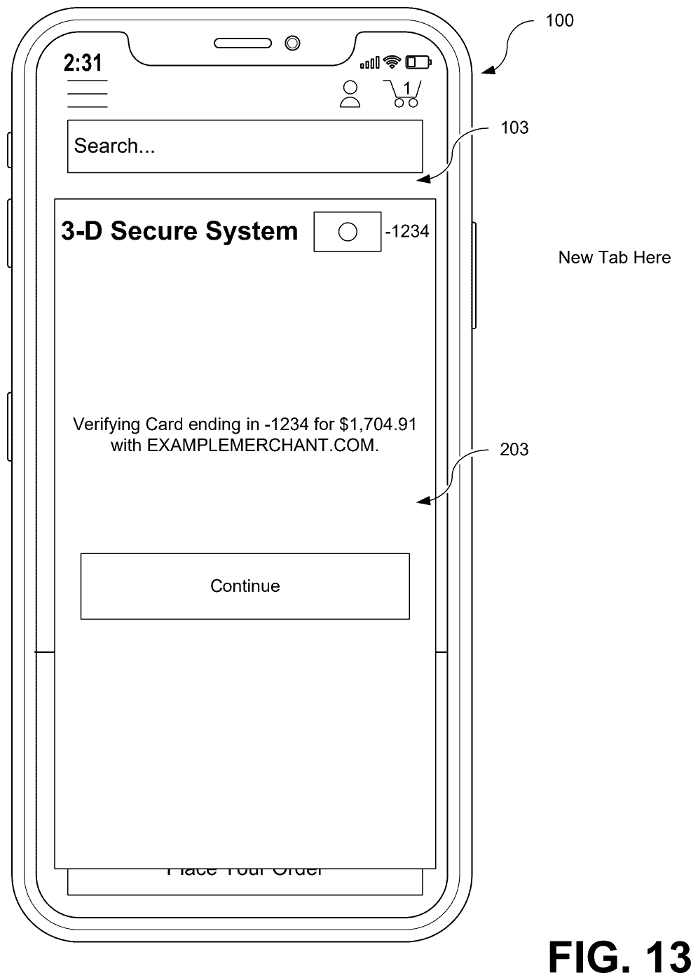

Accordingly, if the purchaser chooses to continue with the authentication, the purchaser could be presented within the iFrame 203 with a message informing the user of information about the transaction to be authorized by the issuer using the 3-D SECURE protocol, an example of which is depicted in FIG. 13. This information could include an identifier indicating the payment instrument used (e.g., the last four (4) digits of a credit, debit, or charge card number) and the amount of the purchase. Other information, such as the identity of the merchant, could also be included in the message presented to the user within the iFrame 203. If the purchaser believes that the transaction information is correct and should be authorized, the purchaser could continue with the verification process. However, for those instances where the version of WebAuthN or the client application or browser executing on the client device 100 does not support cross-origin iFrames or the third-party context, a new tab or WebView could be opened to present the message informing the user of information about the transaction to be authorized by the issuer using the 3-D SECURE protocol.

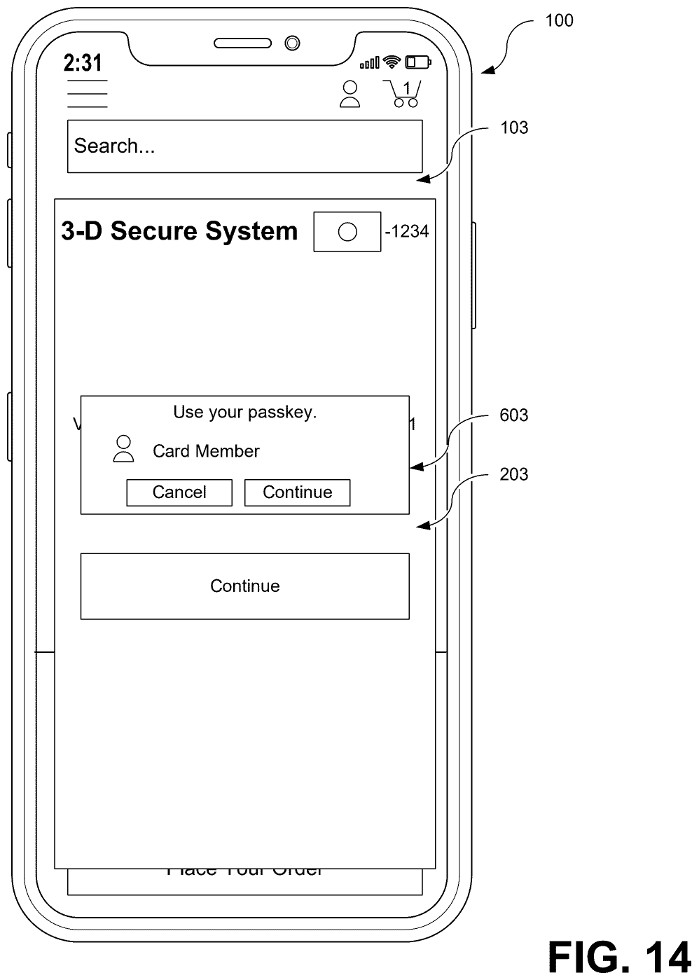

Accordingly, if the purchaser chooses to authorize the transaction, the purchaser could be prompted to authenticate with the client device 100 in order to use his or her passkeys to authorize the transaction, an example of which is depicted in FIG. 14. In some implementations, the purchaser could be presented with a user interface element 603 (e.g., a dialog box or other prompt or input mechanism) asking the purchaser to use his or her passkeys already associated with the issuer. The user interface element 603 could be presented within the iFrame 203 or within a new tab or WebView depending on the version of the WebAuthN protocol in use or the amount of support for WebAuthN protocol provided by the client application or browser executing on the client device 100.

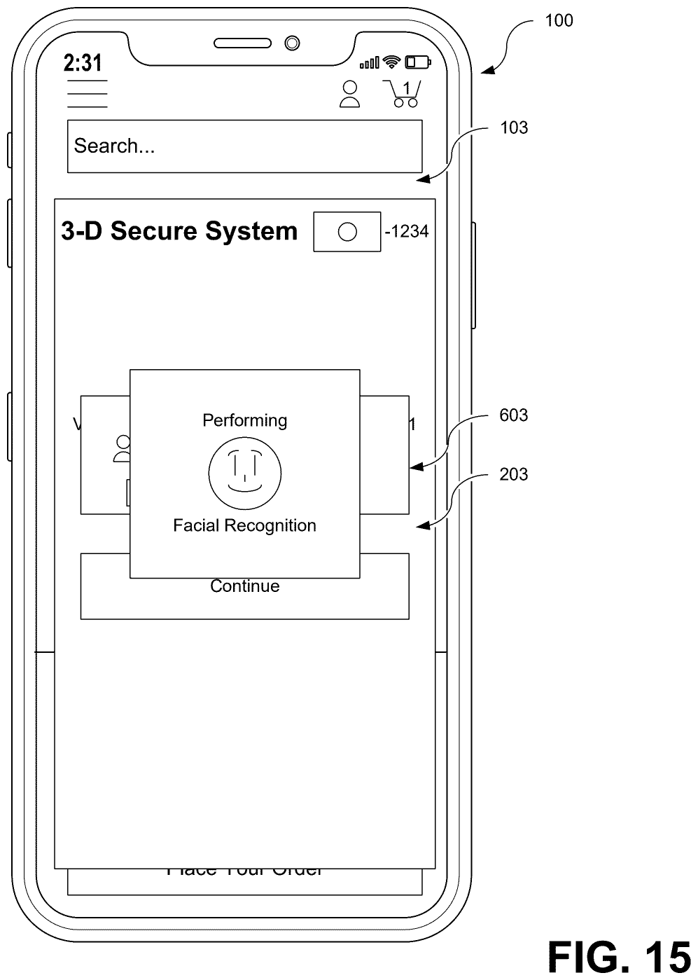

The purchaser could then authorize the use of his or her passkeys though various authentication mechanisms offered by the client device 100. For example, the purchaser could use the front-facing camera 101 to perform facial recognition to verify his or her identity in order to authorize the use of his or passkeys, as illustrated in FIG. 15. As another example, the purchaser could use a fingerprint reader installed on the client device 100 to authenticate his or her identity using his or her fingerprint. Other mechanisms (e.g., entering a personal identification number (PIN) or passcode to authorize access to the passkeys) could also be used.

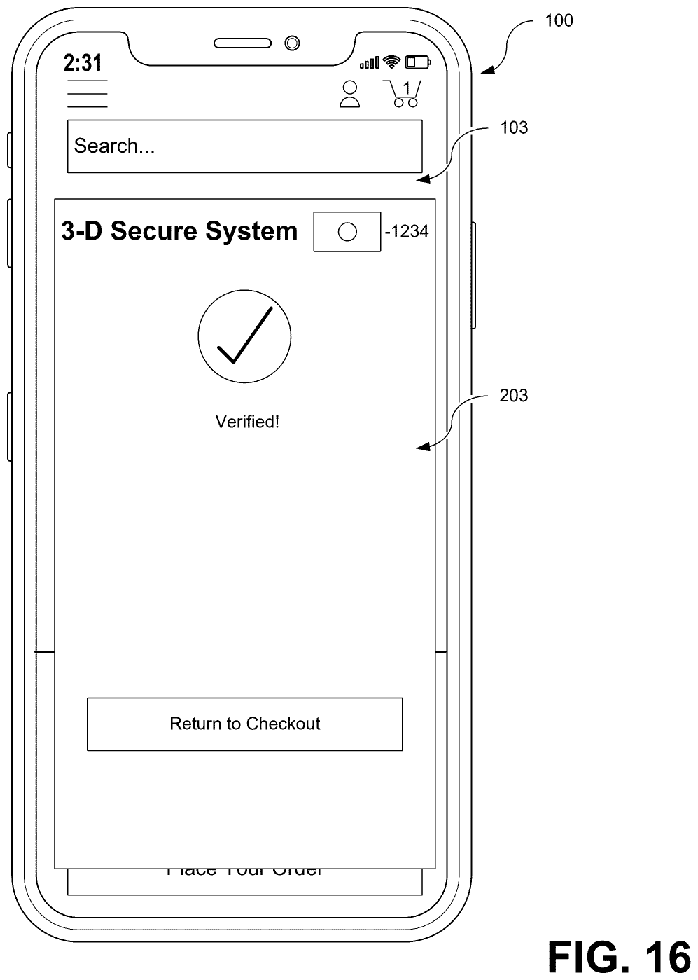

After authorizing the use of his or her passkeys, as depicted in FIG. 15, the purchaser or checkout process could proceed to FIG. 16. Here, a message could be presented to the purchaser within the iFrame 203 to indicate that the purchase has been verified using the 3-D SECURE® protocol. The purchaser could also be prompted to leave the iFrame 203 and return to the checkout process.

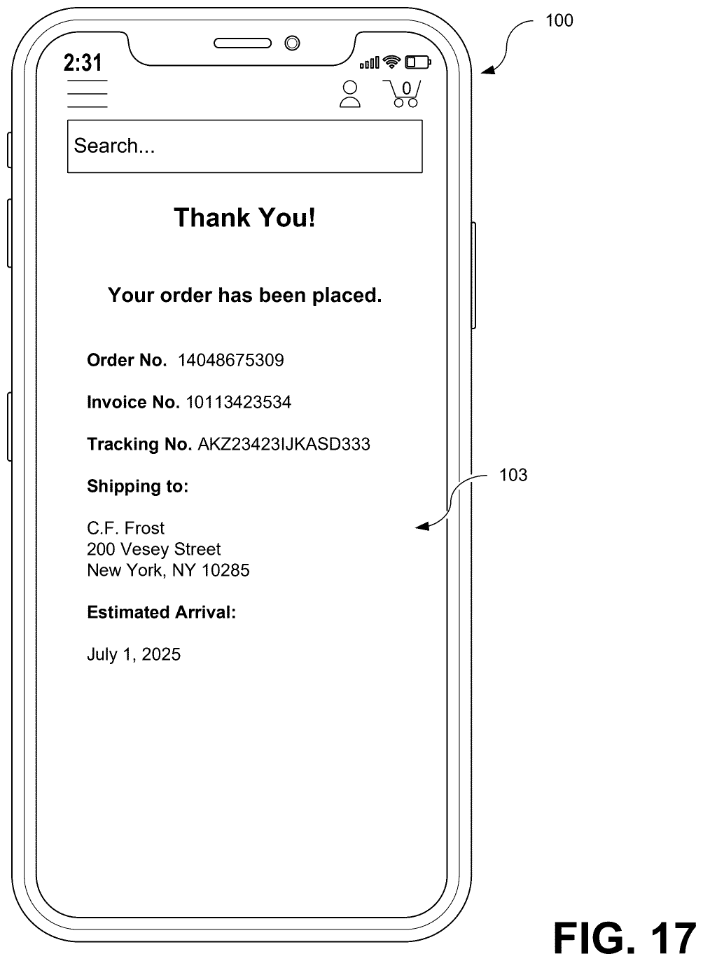

As illustrated in FIG. 17, the iFrame 203 could be closed and the purchaser could be presented within the user interface 103 with updated information related to his or her purchase. This could include a confirmation that the order is complete, estimated arrival, an order number, invoice number, etc.

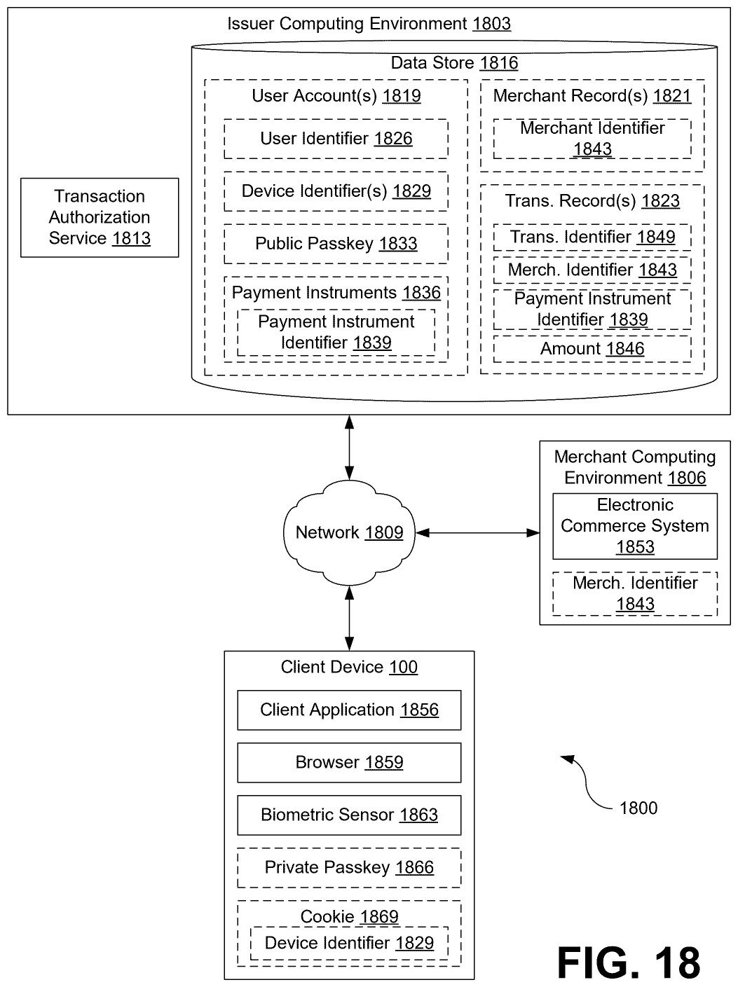

With reference to FIG. 18, shown is a network environment 1800 according to various embodiments. The network environment 1800 can include an issuer computing environment 1803, a merchant computing environment 1806, one or more client devices 100, which can be in data communication with each other via a network 1809.

The network 1890 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 1809 can also include a combination of two or more networks 1809. Examples of networks 1809 can include the Internet, intranets, extranets, virtual private networks (VPNs), and similar networks.

The issuer computing environment 1803 and/or the merchant computing environment 1806 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the issuer computing environment 1803 and/or the merchant computing environment 1806 can employ a plurality of computing devices that can be arranged in one or more server banks or computer banks or other arrangements. Such computing devices can be located in a single installation or can be distributed among many different geographical locations. For example, the issuer computing environment 1803 and/or the merchant computing environment 1806 can include a plurality of computing devices that together can include a hosted computing resource, a grid computing resource or any other distributed computing arrangement. In some cases, the issuer computing environment 1803 and/or the merchant computing environment 1806 can correspond to an elastic computing resource where the allotted capacity of processing, network, storage, or other computing-related resources can vary over time.

Although the issuer computing environment 1803 and the merchant computing environment 1806 are depicted separately for clarity, the components depicted as being executed by or stored within the issuer computing environment 1803 and the merchant computing environment 1806 could be executed by or stored within the same computing environment. This could happen, for example, when the issuer of a payment instrument and the merchant have their operations hosted in a shared tenant environment, such as a public cloud computing service offered by AMAZON®, GOOGLE®, or MICROSOFT®, such as AMAZON WEB SERVICES® (AWS®), GOOGLE CLOUD COMPUTE (GCP®), or MICROSOFT AZURE®.

Various applications or other functionality can be executed in the issuer computing environment 1803. The components executed on the computing environment 1803 include the transaction authorization service 1813, and other applications, services, processes, systems, engines, or functionality not discussed in detail herein.

The transaction authorization service 1813 can be executed to authorized transactions submitted by merchants. For each transaction authorization request, the transaction authorization service 1813 could evaluate it based on a number of credit, fraud, or risk rules to determine the likelihood that the transaction is valid and that the financial risk to the issuer is minimized. This could include determining whether a purchaser has sufficient credit or funds available for the purchase, whether the transaction appears to be a fraudulent or valid transaction based on the nature of the transaction, and whether the transaction appears to be the type of transaction that presents financial risk to the issuer (e.g., risk of non-payment). For transactions that are considered to be at a higher risk for fraud, or match other rules or criteria, the transaction authorization service 1813 could perform additional verification of the purchaser. This could be done, for example, using a version or variation of the 3-D SECURE® protocol including the various embodiments of the present disclosure.

Also, various data is stored in a data store 1816 that is accessible to the issuer computing environment 1803. The data store 1816 can be representative of a plurality of data stores 1816, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 1816 is associated with the operation of the various applications or functional entities described below. This data can include one or more user accounts 1819, one or more merchant records 1821, one or more transaction records 1823, and potentially other data.

Each user account 1819 can represent information about a user who has a relationship with the issuer, such as a purchaser who is using a charge, credit, or debit card from the issuer with a merchant. Accordingly, each user account 1819 can include a user identifier 1826 for the user account 1819, one or more device identifiers 1829 representing respective client devices 100 linked to the user, a public passkey 1833 generated by a client device 100 of the user, and one or more payment instruments 1836 linked to the user.

The user identifier 1826 can include any identifier that uniquely identifies a user account 1819 with respect to another user account 1819. Examples of user identifiers 1826 can include usernames, globally unique identifiers (GUIDs), universally unique identifiers (UUIDs), etc. In some implementations, a user account 1819 can have multiple user identifiers 1826 (e.g., a username and a GUID or UUID).

The device identifier 1829 can include any identifier that uniquely identifiers a client device 100 with respect to another client device 100. Examples of device identifiers 1829 can include hardware identifiers unique to individual client devices 100 (e.g., serial numbers, International Mobile Equipment Identity (IMEI) numbers, media access control (MAC) addresses, etc.) or identifiers assigned to and stored on the client device 100 (e.g., UUIDs or GUIDs assigned to and stored on client devices 100). For example, a device identifier 1829 could include a randomly generated UUID or GUID that is assigned to a client device 100 and stored on the client device 100 in the form of a cookie.

The public passkey 1833 represents the public key of a public-private key pair used for authentication of a registered purchaser using the WebAuthN protocol. Such a public-private key pair can be referred to as a passkey or passkeys. The public-private key pair could be a cryptographic key pair that complies with the Rivest-Shamir-Adleman (RSA) algorithm or with various elliptic curve cryptography (ECC) algorithms.

The payment instruments 1836 represent individual payment instruments linked to the user. This could include various credit, debit, or charge card accounts issued to the user by the issuer. To distinguish between payment instruments 1836, each payment instrument can include a payment instrument identifier 1839 that uniquely identifies one payment instrument 1836 with respect to another. An example of a payment instrument identifier 1839 is an account number. However, in some instances, a payment instrument 1836 could have multiple payment instrument identifiers 1839 (e.g., when an account number has been tokenized).

The merchant records 1821 represent records for individual merchants. This can include information such as the industry the merchant is in (e.g., represented as a “merchant code”), the location of the merchant, etc. Each merchant record 1821 can include a merchant identifier 1843 the uniquely identifies a merchant record 1821 with respect to another merchant record 1821 and, in some instances, uniquely identifies one merchant with respect to another.

The transaction records 1823 can represent information related to individual transactions submitted to the transaction authorization service 1813 for authorization. Accordingly, each transaction record 1823 can include information such as the merchant identifier 1843 of the merchant associated with the transaction, the payment instrument identifier 1839 of the payment instrument used to make or pay for the transaction, the amount 1846 of the transaction, and a transaction identifier 1849 that can uniquely identify a transaction record 1823 with respect to another transaction record 1823 and, in some instance, one transaction with respect to another transaction.

Various applications or other functionality can be executed in the merchant computing environment 1806. The components executed on the merchant computing environment 1806 include an electronic commerce system 1853, and other applications, services, processes, systems, engines, or functionality not discussed in detail herein. The merchant computing environment 1806 or the electronic commerce system 1853 can also store a merchant identifier 1843 that identifies the merchant operating the electronic commerce system 1853 and/or the merchant computing environment 1806.

The electronic commerce system 1853 can be executed to facilitate the online purchase or lease of items or services over the network 1809. The electronic commerce system 1853 can also performs various backend functions associated with the online presence of a merchant in order to facilitate the online purchase of item. For example, the electronic commerce system 1853 can generate web pages that are provided to users for the purpose of selecting items for purchase, rental, download, lease, or other form of consumption. Moreover, electronic commerce systems may include payment processing functionality that, in response to submission of an order and payment credentials, can create and submit a transaction authorization request to the transaction authorization service 1813.

The client device 100 is representative of a plurality of client devices that can be coupled to the network 1809. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 100 or can be connected to the client device 100 through a wired or wireless connection.

The client device 100 can be configured to execute various applications such as a client application 1856, a browser 1859 or other applications. The client application 1856 and/or the browser 1859 can be executed by a client device 100 to access network content served up by the electronic commerce system 1853 or the transaction authorization service 1813, thereby rendering a user interface (e.g., user interface 103) on the display. Although depicted separately, the client application 1856 and/or the browser 1859 could share components or provide functionality used by the other. For example, the client application 1856 could use one or more WebViews to present content in a user interface (e.g., user interface 103) to a user. In these instances, the WebView could be provided by or implemented by the browser 1859.

The client device 100 could also include one or more biometric sensors 1863 to authenticate or otherwise verify the identity of users of the client device 100. Examples of biometric sensors 1863 can include dedicate sensors (e.g., fingerprint readers) or other sensors that can be used for biometric identification (e.g., cameras for facial recognition, microphones for voice recognition, etc.).

Moreover, various data can be stored on a client device 100 for use in the various embodiments of the present disclosure. For example, a private passkey 1866 could be stored on the client device 100 (e.g., within a secure cryptographic coprocessor such as a trusted platform module (TPM) chip, secure enclave, etc.). The private passkey 1866 could be the respective private key for the public passkey 1833 stored in the user account 1819 for the user of the client device 100. As another example, one or more cookies 1869 could be stored by the browser 1859 on the client device 100. Individual cookies 1869 could include various data, such as a device identifier 1829 assigned by the transaction authorization service 1813 to the client device 100.

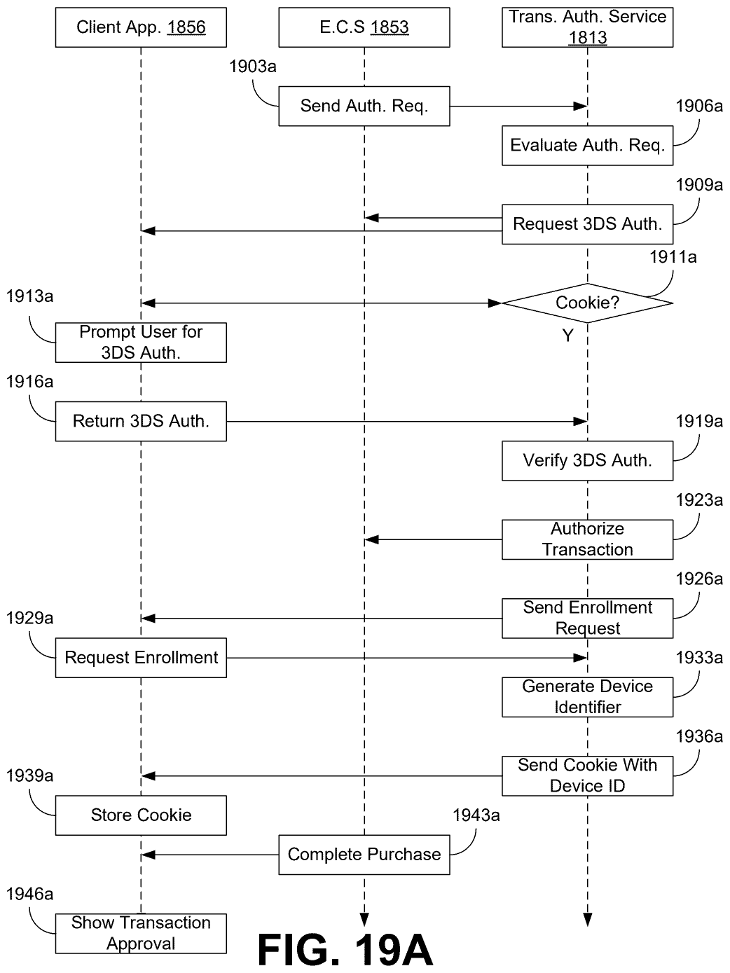

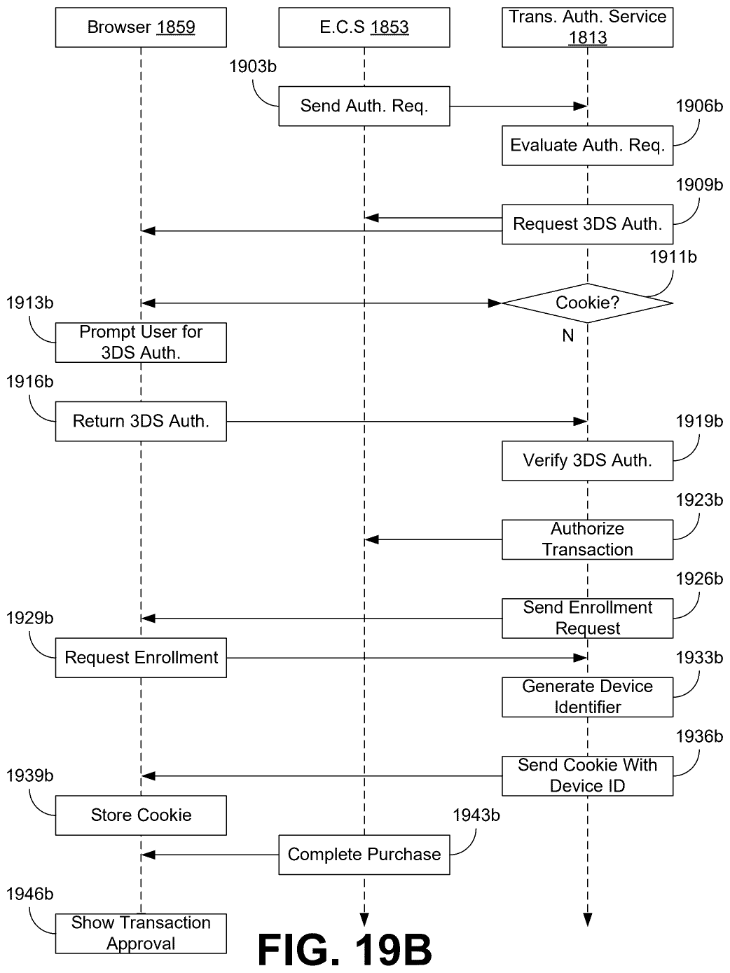

Referring next to FIG. 19A, shown is a sequence diagram that depicts the interactions between the client application 1856, the electronic commerce system 1853, and the transaction authorization service 1813 according to various embodiments of the present disclosure in order to enroll a client device 100 for subsequent 3-D SECURE authentications using passkeys. The sequence diagram of FIG. 19A provides merely an example of the many different types of functional arrangements that can be employed to implement the operations of the depicted portions of the client application 1856, the electronic commerce system 1853, and the transaction authorization service 1813. As an alternative, the sequence diagram of FIG. 19A can be viewed as depicting an example of elements of a method implemented within the network environment 1800.

Beginning with block 1903a, the electronic commerce system 1853 can send a transaction authorization request to the transaction authorization service 1813. The transaction authorization request could include information such as the merchant identifier 1843 of the merchant, the amount 1846 of the transaction, the payment instrument identifier 1839, and potentially other information. The transaction authorization request could be sent to the transaction authorization service 1813 in response to a purchaser attempting to complete a purchase with the merchant using the electronic commerce system 1853 (e.g., complete a checkout process).

Then, at block 1906a, the transaction authorization service 1813 can evaluate the transaction authorization request. For example, the transaction authorization service 1813 could determine if the transaction applies with applicable credit, fraud, or risk rules prior to authorization of the transaction. Depending on the nature of the transaction and the conclusions of the evaluation, the transaction authorization service 1813 could determine that additional authentication of the purchaser is necessary (e.g., secondary authentication using the 3-D SECURE protocol). This could occur, for example, if the transaction is for a high amount, is in an industry where fraud is common, or for any other reason specified by the issuer of the payment instrument 1836 used by the purchaser.

If the transaction authorization service 1813 determines that secondary authentication is desired or required, then subsequently, at block 1909a, the transaction authorization service 1813 can request additional information to authenticate the identity of the purchaser. For example, the transaction authorization service 1813 could send a request to the electronic commerce system 1853 to perform secondary authentication using the 3D-SECURE protocol. This could cause the electronic commerce system 1853 to create or open an iFrame within the user interface (e.g., a webpage or WebView) presented within the client application 1856, such as the iFrame 203 within user interface 103 as depicted in FIGS. 2-8. The iFrame would allow the transaction authorization service 1813 to provide content related to the 3D-SECURE authentication process directly to the client application 1856 for presentation within the user interface presented on the client device 100.

Accordingly, the transaction authorization service 1813 could then send to the client application 1856 a request for a secondary factor of authentication. For example, the transaction authorization service 1813 could provide hypertext markup language (HTML) code to the client application 1856 to present within the iFrame that explains that the user is being requested or required to provide additional authentication information, such as a previously agreed upon password, a one-time password (OTP) concurrently sent to the purchaser through another communications channel (e.g., short message service (SMS), email, etc.), or an OTP generated by an authenticator application according to an agreed upon protocol and seed value (e.g., a time-based one-time password (TOTP), an HMAC-based one-time password (HOTP), etc.). Accordingly, the transaction authorization service could send an OTP to the purchaser through another communications channel (e.g., short message service (SMS), email, etc.) at this point in the sequence diagram.

At block 1911a, the transaction authorization service 1813 could determine whether a cookie 1869 containing a device identifier 1829 for the client device was stored on the client device 100. For example, the transaction authorization service 1813 could send a request to the iFrame created by the client application 1856 to search for the cookie 1869. If the cookie 1869 is present, then the client application 1856 could return the value for the cookie 1869, such as the device identifier 1829 stored by the cookie 1869 on the client device 100. Moreover, the presence of the cookie 1869 serves to indicate that the client device 100 has been previously enrolled by a user (e.g., using the process of FIG. 19A or 19B) for using passkeys with the 3-D SECURE authentication protocol. However, a cookie 1869 is not present on the client device 100, then the transaction authorization service 1813 could proceed with a typical 3-D SECURE authentication workflow and prompt the user of the client device 100 to enroll or otherwise authorize the use of passkeys for future 3-D SECURE authentication workflows or journeys, as described with respect to the subsequent blocks.

Proceeding to block 1913a, the client application 1856 could prompt the user to provide authentication credentials within the iFrame (e.g., the iFrame 203 of FIGS. 2-7) for secondary authentication with the transaction authorization service 1813. For example, the client application 1856 could render HTML code within the iFrame that allows a user to enter and submit a secondary authentication credential, such as a previously agreed upon password, an OTP sent through another communications channel, or an OTP generated by an authenticator application according to an agreed upon protocol and seed value.

Next, at block 1916a, the client application 1856 could return the secondary authentication credentials provided by the user at block 1913a. The return of the secondary authentication credentials completes the 3-D SECURE authentication journey on the client device 100.

Moving on to block 1919a, the transaction authorization service 1813 can verify the secondary authentication credentials (e.g., a password or OTP) to determine if they are authentic. For example, the transaction authorization service 1813 can compare the secondary authentication credentials returned at block 1916a with an expected set of secondary authentication credentials. For instance, if the transaction authorization service 1813 had sent a one-time password (OTP) through another communications channel (e.g., email, phone, etc.), then the transaction authorization service 1813 could compare the received secondary authentication credentials with the OTP provided to the purchaser.

If the secondary authentication credentials were determined to be valid at block 1919a, then the transaction authorization service 1813 could authorize the transaction at block 1923a. The authorization decision could be made in response to both a determination that the secondary authentication credentials were valid and that any other credit, fraud, and risk rules evaluated at 1906a permit the transaction to be authorized. If the transaction is authorized, then the transaction authorization service 1813 could return an authorization response to the electronic commerce system 1853 indicating that the transaction has been authorized or approved.

Subsequently, at block 1926a, the transaction authorization service 1813 could send an enrollment request to the client application 1856 to be presented within the iFrame used for the secondary authentication (e.g., the 3-D SECURE authentication). The enrollment request could prompt the user to use WebAuthN and/or passkeys (e.g., a private passkey 1866) for future authentication using the 3-D SECURE protocol. If the user accepts the enrollment request, the acceptance of the user could be returned to the transaction authorization service 1813.

Depending on the version of the WebAuthN protocol supported by the client application 1856, the functionality discussed in blocks 1929a through 1939a could be implemented in one of several ways. For example, in instances where the client application 1856 supports a version of the WebAuthN protocol that permits the use of passkeys within cross-origin iFrames (e.g., iFrames with a third-party context), the functionality of the following blocks could be implemented using an iFrame. In instances where the client application 1856 does not support a version of the WebAuthN protocol that permits the use of passkeys within cross-origin iFrames (e.g., iFrames with a third-party context), the iFrame displayed by the client application 1856 could open a new tab in a browser 1859 or a new WebView within the client application 1856. The new tab or WebView would have the same origin domain as the transaction authorization service 1813, thereby creating a first-party context within the new tab or WebView that would allow the user of the private passkey 1866. The functionality of the following blocks could then be implemented using the new tab or WebView. Solely for illustrative purposes, the use of an iFrame is discussed with respect to the subsequent blocks of FIG. 19A.

Accordingly, at block 1929a, the enrollment request could be presented by the client application 1856 to the user of the client device 100. For example, as depicted previously in FIGS. 5-7, the user could be prompted to allow the use of passkeys for future authentication. In response, the user could be presented with a user interface element 603 within the iFrame 203 to select a private passkey 1866 associated with the issuer. This could be done, for example by searching for a previously created private passkey 1866 stored on the client device 100 that is associated with the domain of the iFrame (e.g., if the iFrame's domain is “americanexpress.com,” searching for a private passkey 1866 associated with the domain “americanexpress.com”). Identifying information for the private passkey 1866 could be presented within the user interface element 603 to allow the user to confirm the use of the private passkey 1866. Biometric authentication to confirm that the user of the client device 100 is authorized to permit access to or the use of the private passkey 1866 could then be performed using a biometric sensor 1863 of the client device 100, as illustrated in FIG. 7. Examples of biometric identification can include facial recognition, fingerprint identification, voice identification, etc. Once the user confirms the use of the private passkey 1866 for authenticating future transactions and is successfully authenticated by the client device 100, the acceptance of the user could be returned to the transaction authorization service 1813.

Next, at block 1933a, the transaction authorization service 1813 could generate a device identifier 1829 for the client device 100 executing the client application 1856. For example, the transaction authorization service 1813 could randomly generate a UUID or GUID and assign it to the client device 100. This could include updating a user account 1819 associated with user of the client device 100 to include the device identifier 1829 assigned to the client device 100.

Moving on to block 1936a, the transaction authorization service 1813 can include the device identifier 1829 generated at block 1933a in a cookie 1869 sent to the iFrame within the client application 1856. This can be done to cause the device identifier 1829 to be stored locally on the client device 100.

Then, at block 1939a, the iFrame of the client application 1856 can store the cookie 1869 containing the device identifier 1829. Once the cookie 1869 is stored, the client application 1856 could close the iFrame.

Subsequently, at block 1943a, the electronic commerce system 1853 can complete the purchase after the transaction is authorized at block 1923a. For example, the electronic commerce system 1853 could generate an order confirmation message and provide it to the client application 1856. Moreover, the electronic commerce system 1853 could initiate one or more fulfillment processes to cause the order to be processed and/or shipped to the purchaser. Moreover, while depicted sequentially, the functionality of block 1943a could be performed in parallel with the operations depicted and described in blocks 1926a-1939a.

Finally, at block 1946a, the client application 1856 could show the order confirmation message provided by the electronic commerce system 1853 at block 1943a (e.g., as depicted in FIG. 8). The illustrated registration process could then subsequently end.

Referring next to FIG. 19B, shown is a sequence diagram that depicts the interactions between the browser 1859, the electronic commerce system 1853, and the transaction authorization service 1813 according to various embodiments of the present disclosure in order to enroll a client device 100 for subsequent 3-D SECURE authentications using passkeys. The sequence diagram of FIG. 19B provides merely an example of the many different types of functional arrangements that can be employed to implement the operations of the depicted portions of the browser 1859, the electronic commerce system 1853, and the transaction authorization service 1813. As an alternative, the sequence diagram of FIG. 19B can be viewed as depicting an example of elements of a method implemented within the network environment 1800.

Although the sequence diagrams of FIG. 19A and FIG. 19B are very similar, there are some differences. Some users could use mobile applications, such as a client application 1856, provided by a merchant to shop directly with a merchant. However, users could also use a browser 1859 to shop with a merchant by browsing his or her website. Therefore, while many of the operations depicted in FIG. 19A and FIG. 19B are similar or the same, the difference between the process depicted in FIG. 19A versus the process depicted in FIG. 19B is the use of a client application 1856 by the purchaser compared to the use of a browser 1859 by the purchaser.

Beginning with block 1903b, the electronic commerce system 1853 can send a transaction authorization request to the transaction authorization service 1813. The transaction authorization request could include information such as the merchant identifier 1843 of the merchant, the amount 1846 of the transaction, the payment instrument identifier 1839, and potentially other information. The transaction authorization request could be sent to the transaction authorization service 1813 in response to a purchaser attempting to complete a purchase with the merchant using the electronic commerce system 1853 (e.g., complete a checkout process).

Then, at block 1906b, the transaction authorization service 1813 can evaluate the transaction authorization request. For example, the transaction authorization service 1813 could determine if the transaction applies with applicable credit, fraud, or risk rules prior to authorization of the transaction. Depending on the nature of the transaction and the conclusions of the evaluation, the transaction authorization service 1813 could determine that additional authentication of the purchaser is necessary (e.g., secondary authentication using the 3-D SECURE protocol). This could occur, for example, if the transaction is for a high amount, is in an industry where fraud is common, or for any other reason specified by the issuer of the payment instrument 1836 used by the purchaser.

If the transaction authorization service 1813 determines that secondary authentication is desired or required, then subsequently, at block 1909b, the transaction authorization service 1813 can request additional information to authenticate the identity of the purchaser. For example, the transaction authorization service 1813 could send a request to the electronic commerce system 1853 to perform secondary authentication using the 3D-SECURE protocol. This could cause the electronic commerce system 1853 to create or open an iFrame within the user interface (e.g., a webpage or WebView) presented within the browser 1859. The iFrame would allow the transaction authorization service 1813 to provide content related to the 3D-SECURE authentication process directly to the browser 1859 for presentation within the user interface presented on the client device 100.

Accordingly, the transaction authorization service 1813 could then send to the browser 1859 a request for a secondary factor of authentication. For example, the transaction authorization service 1813 could provide hypertext markup language (HTML) code to the browser 1859 to present within the iFrame that explains that the user is being requested or required to provide additional authentication information, such as a previously agreed upon password, a one-time password (OTP) concurrently sent to the purchaser through another communications channel (e.g., short message service (SMS), email, etc.), or an OTP generated by an authenticator application according to an agreed upon protocol and seed value (e.g., a time-based one-time password (TOTP), an HMAC-based one-time password (HOTP), etc.). Accordingly, the transaction authorization service could send an OTP to the purchaser through another communications channel (e.g., short message service (SMS), email, etc.) at this point in the sequence diagram.

At block 1911b, the transaction authorization service 1813 could determine whether a cookie 1869 containing a device identifier 1829 for the client device was stored on the client device 100. For example, the transaction authorization service 1813 could send a request to the iFrame created by the browser 1859 to search for the cookie 1869. If the cookie 1869 is present, then the browser 1859 could return the value for the cookie 1869, such as the device identifier 1829 stored by the cookie 1869 on the client device 100. Moreover, the presence of the cookie 1869 serves to indicate that the client device 100 has been previously enrolled by a user (e.g., using the process of FIG. 19A or 19B) for using passkeys with the 3-D SECURE authentication protocol. However, a cookie 1869 is not present on the client device 100, then the transaction authorization service 1813 could proceed with a typical 3-D SECURE authentication workflow and prompt the user of the client device 100 to enroll or otherwise authorize the use of passkeys for future 3-D SECURE authentication workflows or journeys, as described with respect to the subsequent blocks.

Proceeding to block 1913b, the browser 1859 could prompt the user to provide authentication credentials within the iFrame for secondary authentication with the transaction authorization service 1813. For example, the browser 1859 could render HTML code within the iFrame that allows a user to enter and submit a secondary authentication credential, such as a previously agreed upon password, an OTP sent through another communications channel, or an OTP generated by an authenticator application according to an agreed upon protocol and seed value.

Next, at block 1916b, the browser 1859 could return the secondary authentication credentials provided by the user at block 1913b. The return of the secondary authentication credentials completes the 3-D SECURE authentication journey on the client device 100.

Moving on to block 1919b, the transaction authorization service 1813 can verify the secondary authentication credentials (e.g., a password or OTP) to determine if they are authentic. For example, the transaction authorization service 1813 can compare the secondary authentication credentials returned at block 1916b with an expected set of secondary authentication credentials. For instance, if the transaction authorization service 1813 had sent a one-time password (OTP) through another communications channel (e.g., email, phone, etc.), then the transaction authorization service 1813 could compare the received secondary authentication credentials with the OTP provided to the purchaser.

If the secondary authentication credentials were determined to be valid at block 1919b, then the transaction authorization service 1813 could authorize the transaction at block 1923b. The authorization decision could be made in response to both a determination that the secondary authentication credentials were valid and that any other credit, fraud, and risk rules evaluated at 1906b permit the transaction to be authorized. If the transaction is authorized, then the transaction authorization service 1813 could return an authorization response to the electronic commerce system 1853 indicating that the transaction has been authorized or approved.

Subsequently, at block 1926b, the transaction authorization service 1813 could send an enrollment request to the browser 1859 to be presented within the iFrame used for the secondary authentication (e.g., the 3-D SECURE authentication). The enrollment request could prompt the user to use WebAuthN and/or passkeys (e.g., a private passkey 1866) for future authentication using the 3-D SECURE protocol. If the user accepts the enrollment request, the acceptance of the user could be returned to the transaction authorization service 1813.

Depending on the version of the WebAuthN protocol supported by the browser 1859, the functionality discussed in blocks 1929b through 1939b could be implemented in one of several ways. For example, in instances where the browser 1859 supports a version of the WebAuthN protocol that permits the use of passkeys within cross-origin iFrames (e.g., iFrames with a third-party context), the functionality of the following blocks could be implemented using an iFrame. In instances where the browser 1859 does not support a version of the WebAuthN protocol that permits the use of passkeys within cross-origin iFrames (e.g., iFrames with a third-party context), the iFrame displayed by the browser 1859 could open a new tab in the browser 1859. The new tab would have the same origin domain as the transaction authorization service 1813, thereby creating a first-party context within the new tab that would allow the user of the private passkey 1866. The functionality of the following blocks could then be implemented using the new tab. Solely for illustrative purposes, the use of an iFrame is discussed with respect to the subsequent blocks of FIG. 19B.

Accordingly, at block 1929b, the enrollment request could be presented by the browser 1859 to the user of the client device 100. For example, the user could be prompted to allow the use of passkeys for future authentication. In response, the user could be presented with a user interface element within the iFrame 203 to select a private passkey 1866 associated with the issuer. This could be done, for example by searching for a previously created private passkey 1866 stored on the client device 100 that is associated with the domain of the iFrame (e.g., if the iFrame's domain is “americanexpress.com,” searching for a private passkey 1866 associated with the domain “americanexpress.com”). Identifying information for the private passkey 1866 could be presented within the user interface element 603 to allow the user to confirm the use of the private passkey 1866. Biometric authentication to confirm that the user of the client device 100 is authorized to permit access to or the use of the private passkey 1866 could then be performed using a biometric sensor 1863 of the client device 100, as illustrated in FIG. 7. Examples of biometric identification can include facial recognition, fingerprint identification, voice identification, etc. Once the user confirms the use of the private passkey 1866 for authenticating future transactions and is successfully authenticated by the client device 100, the acceptance of the user could be returned to the transaction authorization service 1813.

Next, at block 1933b, the transaction authorization service 1813 could generate a device identifier 1829 for the client device 100 executing the client application 1856. For example, the transaction authorization service 1813 could randomly generate a UUID or GUID and assign it to the client device 100. This could include updating a user account 1819 associated with user of the client device 100 to include the device identifier 1829 assigned to the client device 100.

Moving on to block 1936b, the transaction authorization service 1813 can include the device identifier 1829 generated at block 1933a in a cookie 1869 sent to the iFrame within the browser 1859. This can be done to cause the device identifier 1829 to be stored locally on the client device 100.

Then, at block 1939b, the iFrame of the browser 1859 can store the cookie 1869 containing the device identifier 1829. Once the cookie 1869 is stored, the browser 1859 could close the iFrame.

Subsequently, at block 1943b, the electronic commerce system 1853 can complete the purchase after the transaction is authorized at block 1923b. For example, the electronic commerce system 1853 could generate an order confirmation message and provide it to the browser 1859. Moreover, the electronic commerce system 1853 could initiate one or more fulfillment processes to cause the order to be processed and/or shipped to the purchaser. Moreover, while depicted sequentially, the functionality of block 1943b could be performed in parallel with the operations depicted and described in blocks 1926b-1939b.

Finally, at block 1946b, the browser 1859 could show the order confirmation message provided by the electronic commerce system 1853 at block 1943b. The illustrated registration process could then subsequently end.

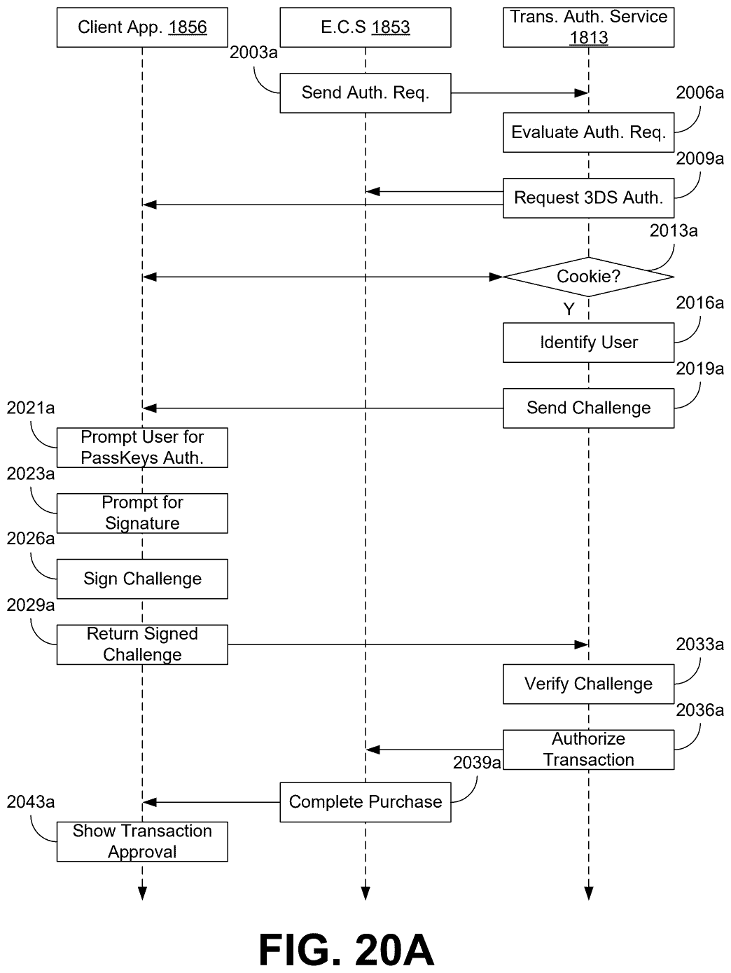

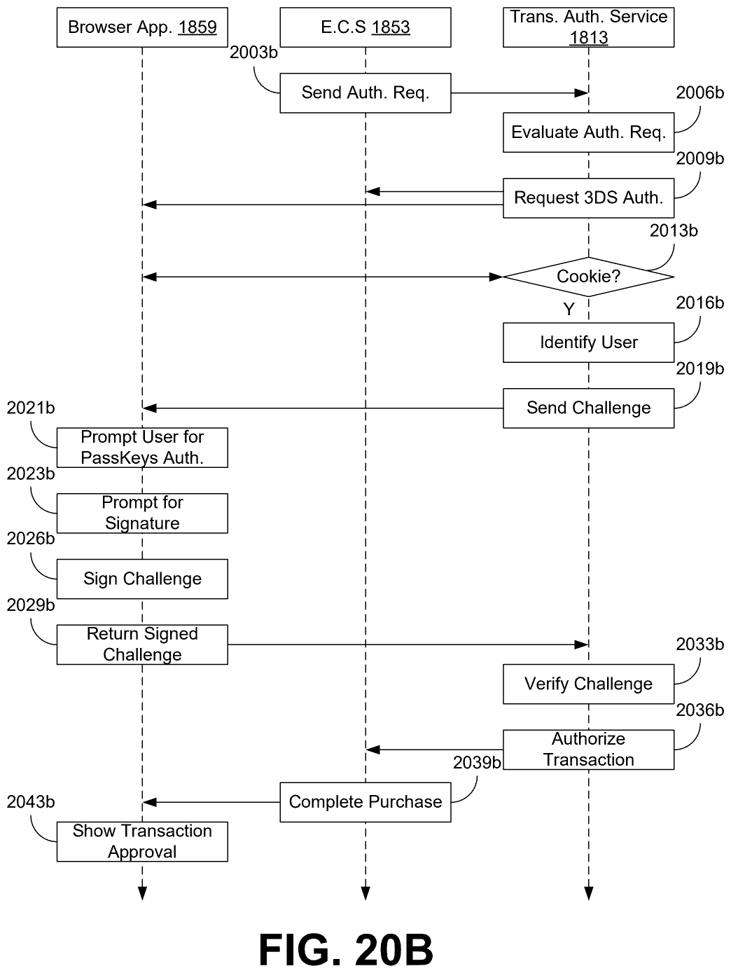

Referring next to FIG. 20A, shown is a sequence diagram that depicts the interactions between the client application 1856, the electronic commerce system 1853, and the transaction authorization service 1813 according to various embodiments of the present disclosure. The sequence diagram of FIG. 20A provides merely an example of the many different types of functional arrangements that can be employed to implement the operations of the depicted portions of the client application 1856, the electronic commerce system 1853, and the transaction authorization service 1813. As an alternative, the sequence diagram of FIG. 20A can be viewed as depicting an example of elements of a method implemented within the network environment 1800.

Beginning with block 2003a, the electronic commerce system 1853 can send a transaction authorization request to the transaction authorization service 1813. The transaction authorization request could include information such as the merchant identifier 1843 of the merchant, the amount 1846 of the transaction, the payment instrument identifier 1839, and potentially other information. The transaction authorization request could be sent to the transaction authorization service 1813 in response to a purchaser attempting to complete a purchase with the merchant using the electronic commerce system 1853 (e.g., complete a checkout process).

Then, at block 2006a, the transaction authorization service 1813 can evaluate the transaction authorization request. For example, the transaction authorization service 1813 could determine if the transaction applies with applicable credit, fraud, or risk rules prior to authorization of the transaction. Depending on the nature of the transaction and the conclusions of the evaluation, the transaction authorization service 1813 could determine that additional authentication of the purchaser is necessary (e.g., secondary authentication using the 3-D SECURE protocol). This could occur, for example, if the transaction is for a high amount, is in an industry where fraud is common, or for any other reason specified by the issuer of the payment instrument 1836 used by the purchaser.

If the transaction authorization service 1813 determines that secondary authentication is desired or required, then subsequently, at block 2009a, the transaction authorization service 1813 can request additional information to authenticate the identity of the purchaser. For example, the transaction authorization service 1813 could send a request to the electronic commerce system 1853 to perform secondary authentication using the 3D-SECURE protocol. This could cause the electronic commerce system 1853 to create or open an iFrame within the user interface (e.g., a webpage or WebView) presented within the client application 1856, such as the iFrame 203 within user interface 103 as depicted in FIGS. 11-16. The iFrame would allow the transaction authorization service 1813 to provide content related to the 3D-SECURE authentication process directly to the client application 1856 for presentation within the user interface presented on the client device 100.

Accordingly, the transaction authorization service 1813 could then send to the client application 1856 a request for a secondary factor of authentication. For example, the transaction authorization service 1813 could provide hypertext markup language (HTML) code to the client application 1856 to present within the iFrame that explains that the user is being requested or required to provide additional authentication information.

Subsequently, at block 2013a, the transaction authorization service 1813 could determine whether a cookie 1869 containing a device identifier 1829 for the client device was stored on the client device 100. For example, the transaction authorization service 1813 could send a request to the iFrame created by the client application 1856 to search for the cookie 1869. If the cookie 1869 is present, then the client application 1856 could return the value for the cookie 1869, such as the device identifier 1829 stored by the cookie 1869 on the client device 100. Moreover, the presence of the cookie 1869 serves to indicate that the client device 100 has been previously enrolled by a user (e.g., using the process of FIG. 19A or 19B) for using passkeys with the 3-D SECURE authentication protocol.

Then, at block 2016a, the transaction authorization service 1813 can identify the user based at least in part on the device identifier 1829 returned by the client application 1856 in response to the request for the cookie 1869 on the client device 100 sent at block 2013a. For example, the transaction authorization service 1813 could search for a user account 1819 with a matching device identifier 1829 associated with it.

Next, at block 2019a, the transaction authorization service 1813 can create and send a challenge to the client application 1856. The challenge could be included in a WebAuthN request payload, where the challenge includes a randomly generated challenge string with at least the transaction amount 1846 and the merchant identifier 1843 for the merchant associated with the transaction appended to the challenge string. The payment instrument identifier 1839 for the payment instrument 1836 used for the transaction could also be appended to the challenge string in some instances. In some implementations, the payment instrument identifier 1839 for the payment instrument 1836 used for the transaction, the amount 1846 of the transaction, and the merchant identifier 1843 could also be separately sent along with the challenge. Moreover, a copy of the challenge can be temporarily saved by the transaction authorization service 1813 for subsequent verification and validation.

Depending on the version of the WebAuthN protocol supported by the client application 1856, the functionality discussed in blocks 2021a through 2029a could be implemented in one of several ways. For example, in instances where the client application 1856 supports a version of the WebAuthN protocol that permits the use of passkeys within cross-origin iFrames (e.g., iFrames with a third-party context), the functionality of the following blocks could be implemented using an iFrame. In instances where the client application 1856 does not support a version of the WebAuthN protocol that permits the use of passkeys within cross-origin iFrames (e.g., iFrames with a third-party context), the iFrame displayed by the client application 1856 could open a new tab in a browser 1859 or a new WebView within the client application 1856. The new tab or WebView would have the same origin domain as the transaction authorization service 1813, thereby creating a first-party context within the new tab or WebView that would allow the user of the private passkey 1866. The functionality of the following blocks could then be implemented using the new tab or WebView. Solely for illustrative purposes, the use of an iFrame is discussed with respect to the subsequent blocks of FIG. 20A.

Proceeding to block 2021a, the client application 1856 could prompt the user to authorize the use of the private passkey 1866 of the user within the iFrame (e.g., the iFrame 203 of FIGS. 11-16) for secondary authentication with the transaction authorization service 1813. For example, the client application 1856 could present to the user a message indicating at least the amount 1846 of the transaction, the merchant with whom the transaction is being made (based at least in part on the merchant identifier 1843), and the payment instrument identifier 1839 of the payment instrument 1836 being used for the transaction. An example presentation is previously depicted in FIG. 13. In some instances, this data could be parsed and extracted from the challenge to present to the user. In other instances, these values are sent along with the challenge and could be read and presented accordingly.

If, after evaluating the information included in the prompt presented at block 2021a, the user chooses to authorize the transaction using the private passkey 1866 of the user, then the process can proceed to block 2023a. Here, the client application 1856 can prompt the purchaser to use his or her private passkey 1866 (e.g., as depicted in FIG. 14) to authorize the transaction (e.g., by signing the challenge). The client application 1856 could select the private passkey 1866 for use based at least in part on the domain associated with the iFrame created by the client application 1856. For example, if the iFrame's domain is “americanexpress.com,” the client application 1856 could search for a private passkey 1866 associated with the domain “americanexpress.com”. The private passkey 1866 could then be presented to the user to allow the user to confirm that the correct private passkey 1866 is being used to authorize the transaction (e.g., as depicted in FIG. 14). If the user confirms the use of the private passkey 1866 for authorizing the transaction, then the client device could authenticate the user with a biometric sensor 1863 of the client device 100. Biometric authentication to confirm that the user of the client device 100 is authorized to permit access to or the use of the private passkey 1866 could then be performed using a biometric sensor 1863 of the client device 100, as illustrated in FIG. 15. Examples of biometric identification can include facial recognition, fingerprint identification, voice identification, etc.

Moving on to block 2026a, the client application 1856 can sign the challenge using the authorized private passkey 1866. For example, the client application 1856 could use the private passkey 1866 to generate a cryptographic signature of the challenge provided at block 2019a. As another example, the client application 1856, having authenticated the user at block 2023a, could provide the challenge to a cryptographic coprocessor (e.g., a trusted platform module (TPM) chip, a secure enclave, etc.) to sign using the private passkey 1866 stored by the cryptographic coprocessor.

At block 2029a, the client application 1856 could either return the signed challenge, which can include both the challenge received at block 2019a and the signature generated at block 2026a, to the transaction authorization service 1813 or only the signature itself. For example, if the transaction authorization service 1813 stored a copy of the signed challenge at block 2019a, then only the cryptographic signature has to be returned. However, if the transaction authorization service 1813 did not temporarily store a copy of the challenge, then the signed challenge can be returned.

Next, at block 2033a, the client application 1856 can verify the challenge. This can be done by using the public passkey 1833 associated with the user account 1819 identified at block 2016a to verify the signature generated by the private passkey 1866 at block 2026a. If the signature is able to be verified with the public passkey 1833, then the transaction authorization service 1813 can conclude that the purchaser used the client device 100 to review and approve the transaction with the merchant for the amount 1846 specified using the payment instrument 1836 identified.

In response to verification of the challenge at block 2033a, the transaction authorization service 1813 can authorize the transaction at block 2036a. The authorization decision could be made in response to both a determination that the challenge was valid and that any other credit, fraud, and risk rules evaluated at 2006a permit the transaction to be authorized. If the transaction is authorized, then the transaction authorization service 1813 could return an authorization response to the electronic commerce system 1853 indicating that the transaction has been authorized or approved.

Then, at block 2039a, the electronic commerce system 1853 can complete the purchase after the transaction is authorized at block 2036a. For example, the electronic commerce system 1853 could generate an order confirmation message and provide it to the client application 1856. Moreover, the electronic commerce system 1853 could initiate one or more fulfillment processes to cause the order to be processed and/or shipped to the purchaser.

Finally, at block 2043a, the client application 1856 could show the order confirmation message provided by the electronic commerce system 1853 at block 2039a (e.g., as depicted in FIG. 17). The illustrated authentication process could then subsequently end.

Referring next to FIG. 20B, shown is a sequence diagram that depicts the interactions between the browser 1859, the electronic commerce system 1853, and the transaction authorization service 1813 according to various embodiments of the present disclosure. The sequence diagram of FIG. 20B provides merely an example of the many different types of functional arrangements that can be employed to implement the operations of the depicted portions of the browser 1859, the electronic commerce system 1853, and the transaction authorization service 1813. As an alternative, the sequence diagram of FIG. 20B can be viewed as depicting an example of elements of a method implemented within the network environment 1800.

Although the sequence diagrams of FIG. 20A and FIG. 20B are very similar, there are some differences. Some users could use mobile applications, such as a client application 1856, provided by a merchant to shop directly with a merchant. However, users could also use a browser 1859 to shop with a merchant by browsing his or her website. Therefore, while many of the operations depicted in FIG. 20A and FIG. 20B are similar or the same, the difference between the process depicted in FIG. 20A versus the process depicted in FIG. 20B is the use of a client application 1856 by the purchaser compared to the use of a browser 1859 by the purchaser.

Beginning with block 2003b, the electronic commerce system 1853 can send a transaction authorization request to the transaction authorization service 1813. The transaction authorization request could include information such as the merchant identifier 1843 of the merchant, the amount 1846 of the transaction, the payment instrument identifier 1839, and potentially other information. The transaction authorization request could be sent to the transaction authorization service 1813 in response to a purchaser attempting to complete a purchase with the merchant using the electronic commerce system 1853 (e.g., complete a checkout process).

Then, at block 2006b, the transaction authorization service 1813 can evaluate the transaction authorization request. For example, the transaction authorization service 1813 could determine if the transaction applies with applicable credit, fraud, or risk rules prior to authorization of the transaction. Depending on the nature of the transaction and the conclusions of the evaluation, the transaction authorization service 1813 could determine that additional authentication of the purchaser is necessary (e.g., secondary authentication using the 3-D SECURE protocol). This could occur, for example, if the transaction is for a high amount, is in an industry where fraud is common, or for any other reason specified by the issuer of the payment instrument 1836 used by the purchaser.

If the transaction authorization service 1813 determines that secondary authentication is desired or required, then subsequently, at block 2009b, the transaction authorization service 1813 can request additional information to authenticate the identity of the purchaser. For example, the transaction authorization service 1813 could send a request to the electronic commerce system 1853 to perform secondary authentication using the 3D-SECURE protocol. This could cause the electronic commerce system 1853 to create or open an iFrame within the user interface (e.g., a webpage or WebView) presented within the browser 1859. The iFrame would allow the transaction authorization service 1813 to provide content related to the 3D-SECURE authentication process directly to the client application 1856 for presentation within the user interface presented on the client device 100.

Accordingly, the transaction authorization service 1813 could then send to the client application 1856 a request for a secondary factor of authentication. For example, the transaction authorization service 1813 could provide hypertext markup language (HTML) code to the client application 1856 to present within the iFrame that explains that the user is being requested or required to provide additional authentication information.

Subsequently, at block 2013b, the transaction authorization service 1813 could determine whether a cookie 1869 containing a device identifier 1829 for the client device was stored on the client device 100. For example, the transaction authorization service 1813 could send a request to the iFrame created by the browser 1859 to search for the cookie 1869. If the cookie 1869 is present, then the browser 1859 could return the value for the cookie 1869, such as the device identifier 1829 stored by the cookie 1869 on the client device 100. Moreover, the presence of the cookie 1869 serves to indicate that the client device 100 has been previously enrolled by a user (e.g., using the process of FIG. 19A or 19B) for using passkeys with the 3-D SECURE authentication protocol.

Then, at block 2016b, the transaction authorization service 1813 can identify the user based at least in part on the device identifier 1829 returned by the browser 1859 in response to the request for the cookie 1869 on the client device 100 sent at block 2013b. For example, the transaction authorization service 1813 could search for a user account 1819 with a matching device identifier 1829 associated with it.

Next, at block 2019b, the transaction authorization service 1813 can create and send a challenge to the browser 1859. The challenge could be included in a WebAuthN request payload, where the challenge includes a randomly generated challenge string with at least the transaction amount 1846 and the merchant identifier 1843 for the merchant associated with the transaction appended to the challenge string. The payment instrument identifier 1839 for the payment instrument 1836 used for the transaction could also be appended to the challenge string in some instances. In some implementations, the payment instrument identifier 1839 for the payment instrument 1836 used for the transaction, the amount 1846 of the transaction, and the merchant identifier 1843 could also be separately sent along with the challenge. Moreover, a copy of the challenge can be temporarily saved by the transaction authorization service 1813 for subsequent verification and validation.

Depending on the version of the WebAuthN protocol supported by the browser 1859, the functionality discussed in blocks 2021b through 2029b could be implemented in one of several ways. For example, in instances where the browser 1859 supports a version of the WebAuthN protocol that permits the use of passkeys within cross-origin iFrames (e.g., iFrames with a third-party context), the functionality of the following blocks could be implemented using an iFrame. In instances where the browser 1859 does not support a version of the WebAuthN protocol that permits the use of passkeys within cross-origin iFrames (e.g., iFrames with a third-party context), the iFrame displayed by the browser 1859 could open a new tab in the browser 1859. The new tab or WebView would have the same origin domain as the transaction authorization service 1813, thereby creating a first-party context within the new tab that would allow the user of the private passkey 1866. The functionality of the following blocks could then be implemented using the new tab. Solely for illustrative purposes, the use of an iFrame is discussed with respect to the subsequent blocks of FIG. 20B.

Proceeding to block 2021b, the browser 1859 could prompt the user to authorize the use of the private passkey 1866 of the user within the iFrame for secondary authentication with the transaction authorization service 1813. For example, the browser 1859 could present to the user a message indicating at least the amount 1846 of the transaction, the merchant with whom the transaction is being made (based at least in part on the merchant identifier 1843), and the payment instrument identifier 1839 of the payment instrument 1836 being used for the transaction. In some instances, this data could be parsed and extracted from the challenge to present to the user. In other instances, these values are sent along with the challenge and could be read and presented accordingly.

If, after evaluating the information included in the prompt presented at block 2021b, the user chooses to authorize the transaction using the private passkey 1866 of the user, then the process can proceed to block 2023b. Here, the browser 1859 can prompt the purchaser to use his or her private passkey 1866 to authorize the transaction (e.g., by signing the challenge). The browser 1859 could select the private passkey 1866 for use based at least in part on the domain associated with the iFrame created by the client application 1856. For example, if the iFrame's domain is “americanexpress.com,” the client application 1856 could search for a private passkey 1866 associated with the domain “americanexpress.com”. The private passkey 1866 could then be presented to the user to allow the user to confirm that the correct private passkey 1866 is being used to authorize the transaction. If the user confirms the use of the private passkey 1866 for authorizing the transaction, then the client device could authenticate the user with a biometric sensor 1863 of the client device 100. Biometric authentication to confirm that the user of the client device 100 is authorized to permit access to or the use of the private passkey 1866 could then be performed using a biometric sensor 1863 of the client device 100. Examples of biometric identification can include facial recognition, fingerprint identification, voice identification, etc.

Moving on to block 2026b, the browser 1859 can sign the challenge using the authorized private passkey 1866. For example, the browser 1859 could use the private passkey 1866 to generate a cryptographic signature of the challenge provided at block 2019b. As another example, the browser 1859, having authenticated the user at block 2023b, could provide the challenge to a cryptographic coprocessor (e.g., a trusted platform module (TPM) chip, a secure enclave, etc.) to sign using the private passkey 1866 stored by the cryptographic coprocessor.

At block 2029b, the browser 1859 could either return the signed challenge, which can include both the challenge received at block 2019b and the signature generated at block 2026b, to the transaction authorization service 1813 or only the signature itself. For example, if the transaction authorization service 1813 stored a copy of the signed challenge at block 2019b, then only the cryptographic signature has to be returned. However, if the transaction authorization service 1813 did not temporarily store a copy of the challenge, then the signed challenge can be returned.

Next, at block 2033b, the browser 1859 can verify the challenge. This can be done by using the public passkey 1833 associated with the user account 1819 identified at block 2016b to verify the signature generated by the private passkey 1866 at block 2026b. If the signature is able to be verified with the public passkey 1833, then the transaction authorization service 1813 can conclude that the purchaser used the client device 100 to review and approve the transaction with the merchant for the amount 1846 specified using the payment instrument 1836 identified.

In response to verification of the challenge at block 2033b, the transaction authorization service 1813 can authorize the transaction at block 2036b. The authorization decision could be made in response to both a determination that the challenge was valid and that any other credit, fraud, and risk rules evaluated at 2006b permit the transaction to be authorized. If the transaction is authorized, then the transaction authorization service 1813 could return an authorization response to the electronic commerce system 1853 indicating that the transaction has been authorized or approved.

Then, at block 2039b, the electronic commerce system 1853 can complete the purchase after the transaction is authorized at block 2036b. For example, the electronic commerce system 1853 could generate an order confirmation message and provide it to the browser 1859. Moreover, the electronic commerce system 1853 could initiate one or more fulfillment processes to cause the order to be processed and/or shipped to the purchaser.

Finally, at block 2043b, the browser 1859 could show the order confirmation message provided by the electronic commerce system 1853 at block 2039b (e.g., as depicted in FIG. 17). The illustrated authentication process could then subsequently end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 1800.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a client device comprising a processor and a memory; and
machine-readable instructions stored in the memory that, when executed by the processor, cause the client device to at least:
prompt a user of the client device to enter a secondary factor of authentication for a transaction;
send the secondary factor of authentication to a transaction authorization service;
receive, from the transaction authorization service, a request to enable biometric authentication as a form for the secondary factor of authentication, the request comprising a device identifier for the computing device generated by the transaction authorization service;
prompt the user to enable biometric authentication as the form for the secondary factor of authentication; and
in response to a selection to enable biometric authentication as the form for the secondary factor of authentication, store the device identifier in a cookie readable by the machine-readable instructions.

2. The system of claim 1, wherein the transaction is a first transaction and the machine-readable instructions further cause the client device to at least:
prompt the user of the client device to enter the secondary factor of authentication for a second transaction, wherein the prompt includes transaction information and merchant information;
in response to a selection to enter the secondary factor of authentication, perform biometric authentication of the user of the client device;
in response to successful biometric authentication of the second transaction, cryptographically sign with a private passkey a challenge comprising the transaction information and the merchant information to a cryptographic signature of the challenge; and
send the cryptographic signature of the challenge to the transaction authorization service.

3. The system of claim 2, wherein challenge further comprises a text string, and the transaction information and merchant information are concatenated to the text string.

4. The system of claim 2, wherein the machine-readable instructions further cause the client device to at least:
receive, from the transaction authorization service, a confirmation message indicating that the second transaction has been approved; and
show, on a display of the client device, a notification that the second transaction has been approved.

5. The system of claim 1, wherein client device comprises a camera and the machine-readable instructions that cause the client device to perform biometric authentication of the user of the client device further cause the client device to at least:
obtain an image of the face of the user of the client device with the camera; and
authenticate the user of the client device based at least in part on the image of the face of the user.

6. The system of claim 1, wherein client device comprises a fingerprint reader and the machine-readable instructions that cause the client device to perform biometric authentication of the user of the client device further cause the client device to at least:
obtain a representation of a fingerprint of the user of the client device with the fingerprint reader; and
authenticate the user of the client device based at least in part on the representation of the fingerprint of the user of the client device.

7. The system of claim 1, wherein client device comprises a microphone and the machine-readable instructions that cause the client device to perform biometric authentication of the user of the client device further cause the client device to at least:
record a voice sample of the user of the client device with the microphone; and
authenticate the user of the client device based at least in part on the voice sample of the user.

8. A method by a client device, comprising:
prompting a user of the client device to enter a secondary factor of authentication for a transaction;
sending the secondary factor of authentication to a transaction authorization service;
receiving, from the transaction authorization service, a request to enable biometric authentication as a form for the secondary factor of authentication, the request comprising a device identifier for the computing device generated by the transaction authorization service;
prompting the user to enable biometric authentication as the form for the secondary factor of authentication; and
in response to a selection to enable biometric authentication as the form for the secondary factor of authentication, storing the device identifier in a cookie on the client device.

9. The method of claim 8, wherein the transaction is a first transaction and the method further comprising:
prompting the user of the client device to enter the secondary factor of authentication for a second transaction, wherein the prompt includes transaction information and merchant information;
in response to a selection to enter the secondary factor of authentication, performing biometric authentication of the user of the client device;
in response to successful biometric authentication of the second transaction, cryptographically signing with a private passkey a challenge comprising the transaction information and the merchant information to a cryptographic signature of the challenge; and
sending the cryptographic signature of the challenge to the transaction authorization service.

10. The method of claim 9, wherein challenge further comprises a text string, and the transaction information and merchant information are concatenated to the text string.

11. The method of claim 9, further comprising:
receiving, from the transaction authorization service, a confirmation message indicating that the second transaction has been approved; and
showing, on a display of the client device, a notification that the second transaction has been approved.

12. The method of claim 8, wherein client device comprises a camera and performing biometric authentication of the user of the client device further comprises:
obtain an image of the face of the user of the client device with the camera; and
authenticate the user of the client device based at least in part on the image of the face of the user.

13. The method of claim 8, wherein client device comprises a fingerprint reader and performing biometric authentication of the user of the client device further comprises:
obtaining a representation of a fingerprint of the user of the client device with the fingerprint reader; and
authenticating the user of the client device based at least in part on the representation of the fingerprint of the user of the client device.

14. The method of claim 8, wherein client device comprises a microphone and performing biometric authentication of the user of the client device further comprises:
record a voice sample of the user of the client device with the microphone; and
authenticate the user of the client device based at least in part on the voice sample of the user.

15. (canceled)

16. (canceled)

17. (canceled)

18. (canceled)

19. (canceled)

20. (canceled)

21. A non-transitory computer-readable medium embodying a program executable by at least one processor, wherein the program, when executed, causes the at least one processor at least:
prompt a user of a client device to enter a secondary factor of authentication for a transaction;
send the secondary factor of authentication to a transaction authorization service;
receive, from the transaction authorization service, a request to enable biometric authentication as a form for the secondary factor of authentication, the request comprising a device identifier for the computing device generated by the transaction authorization service;
prompt the user to enable biometric authentication as the form for the secondary factor of authentication; and
in response to a selection to enable biometric authentication as the form for the secondary factor of authentication, store the device identifier in a cookie readable by the program.

22. The non-transitory computer-readable medium of claim 21, wherein the transaction is a first transaction and the program further cause the client device to at least:
prompt the user of the client device to enter the secondary factor of authentication for a second transaction, wherein the prompt includes transaction information and merchant information;
in response to a selection to enter the secondary factor of authentication, perform biometric authentication of the user of the client device;
in response to successful biometric authentication of the second transaction, cryptographically sign with a private passkey a challenge comprising the transaction information and the merchant information to a cryptographic signature of the challenge; and
send the cryptographic signature of the challenge to the transaction authorization service.

23. The non-transitory computer-readable medium of claim 22, wherein the challenge further comprises a text string, and the transaction information and merchant information are concatenated to the text string.

24. The non-transitory computer-readable medium of claim 22, wherein the program further causes the client device to at least:
receive, from the transaction authorization service, a confirmation message indicating that the second transaction has been approved; and
show, on a display of the client device, a notification that the second transaction has been approved.

25. The non-transitory computer-readable medium of claim 21, wherein the client device comprises a camera and the program that causes the client device to perform biometric authentication of the user of the client device further cause the client device to at least:
obtain an image of the face of the user of the client device with the camera; and
authenticate the user of the client device based at least in part on the image of the face of the user.

26. The non-transitory computer-readable medium of claim 21, wherein the client device comprises a fingerprint reader and the program that causes the client device to perform biometric authentication of the user of the client device further cause the client device to at least:
obtain a representation of a fingerprint of the user of the client device with the fingerprint reader; and
authenticate the user of the client device based at least in part on the representation of the fingerprint of the user of the client device.
